(19) United States
(12) Patent Application Publication
(10) Pub. No.: US 2025/0343713 A1
(43) Pub. Date: Nov. 6, 2025

(54) PREDICTION BASED FD QUANTIZER FOR DL RS SAMPLES INDICATION TO SUPPORT TX PRE-EQUALIZATION

(71) Applicant: QUALCOMM Incorporated, San Diego, CA (US)

(72) Inventors: Tom BARAK, Rehovot (IL); Michael LEVITSKY, Rehovot (IL); Daniel PAZ, Atlit (IL)

(21) Appl. No.: 18/656,282

(22) Filed: May 6, 2024

(51) Int. Cl. H04L 25/03; H04L 5/00

(52) U.S. Cl. CPC H04L 25/03343; H04L 5/005

(57) ABSTRACT

A prediction based frequency domain quantizer for DL reference signal samples indication to support transmit pre-equalization is described. An apparatus is configured to predictively quantize a DL reference signal based on a prior sample of the DL reference signal. The apparatus is configured to provide, for a UE, a quantized representation of the DL reference signal and a set of controlled parameters. The apparatus is configured to receive, from the UE, pre-equalized data in accordance with a channel estimation associated with a reconstructed representation of the DL reference signal after quantization.

### TECHNICAL FIELD

The present disclosure relates generally to communication systems, and more particularly, to wireless systems utilizing reference signals and extended reality (XR) devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, and the method may be performed by or at, an XR device and/or a user equipment (UE). The apparatus is configured to predictively quantize a downlink (DL) reference signal based on a prior sample of the DL reference signal. The apparatus is also configured to provide, for a UE, a quantized representation of the DL reference signal and a set of controlled parameters. The apparatus is also configured to receive, from the UE, pre-equalized data in accordance with a channel estimation associated with a reconstructed representation of the DL reference signal after quantization.

In the aspect, the method includes predictively quantizing a DL reference signal based on a prior sample of the DL reference signal. The method also includes providing, for a UE, a quantized representation of the DL reference signal and a set of controlled parameters. The method also includes receiving, from the UE, pre-equalized data in accordance with a channel estimation associated with a reconstructed representation of the DL reference signal after quantization.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extended reality (XR) traffic.

FIG. 5A is a diagram illustrating an example of an XR traffic flow.

FIG. 5B is a block diagram illustrating a DL RS processing flow between an XR device and a companion device such as a UE.

FIG. 6 is a call flow diagram for wireless communications, in accordance with various aspects of the present disclosure.

FIG. 7 is a diagram illustrating an example of differential pulse code modulation (DPCM) prediction-based quantization and compression for sampling and pre-equalization, in accordance with various aspects of the present disclosure.

FIG. 8 is a diagram illustrating an example of DPCM reconstruction for sampling and pre-equalization, in accordance with various aspects of the present disclosure.

FIG. 9 is a diagram illustrating examples of DPCM prediction-based quantization with correlation coefficient evaluation for sampling and pre-equalization, in accordance with various aspects of the present disclosure.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

FIG. 13A is a diagram showing an example XR split architecture including a split of XR processing between an XR device and a companion device.

FIG. 13B illustrates an example of a lower complexity device that supports XR traffic and provides sensor data to a higher complexity companion device.

### DETAILED DESCRIPTION

Wireless communication networks may be designed to support communications between network nodes (e.g., base stations, gNBs, etc.)/network entities (e.g., in a core network), UEs, and/or XR devices. For instance, an XR device may communicate with a UE or a “puck” through a sidelink connection in 5G NR, 6G, and/or the like, to facilitate the usage of XR applications. XR traffic may include communications for virtual reality (VR), mixed reality (MR), augmented reality (AR), and/or the like. XR devices may include XR glasses, XR goggles, and/or other XR devices to provide a user with an XR experience.

However, XR technology has many challenges and unsolved issues that limit readiness for massive commercialization and adoption. Among such issues are being light-weight appropriate for long-time use, e.g., “on the go,” ideally comparable with a regular eye glasses which have approximately 30 g to 40 g weight, as XR devices may thus rely on a light weigh battery among the rest. Additionally, issues include limited processing complexity and power consumption to comply with available heat dissipation ability on the XR glasses/XR goggles/other XR devices (e.g., which may be much smaller than a typical UE for example, such as a smartphone, as it is proportional to the surface size of goggles/glasses, which is much smaller). For smart XR wearable goggles, the power consumption limit from the point of view of heat dissipation may be limited to only few watts. Likewise, it may be helpful for the XR device to a reduced power consumption to allow a light weight battery and a reasonable battery lifetime. These issues are extremely challenging keeping in mind that heavy processing may be utilized to support many XR applications. A stand-alone XR product may not comply with the above “on the go” requirements and may be relevant only for some specific applications/static- and short-time usage scenarios, which allow to assume a higher form factor head mounted device (HMD) usage. In order to maintain a lighter weight, useful battery lifetime, and/or heat dissipation capabilities of an XR device, some of the XR related processing may be shifted to a companion device with a split XR approach to reduce complexity on the XR device. A split XR approach can move some of the rendering related processing to a companion device, while maintaining processing components on the XR device for different end-to-end (E2E) considerations (e.g., a photon-to-motion latency consideration, an XR-to-companion device wireless link capacity, communication link power consumption for long range links, etc.). And while split XR options significantly reduce power consumption on XR devices, the power consumption can still be high even for a less demanding video quality/user experience benchmark and less demanding applications such that this split scenario does not completely solve the technology-limiting factors mentioned above, and does not allow support of more demanding premium XR application (e.g., where frames per second (fps)≥120 Hz, where video formats ≥8 k, etc.). The split options above may assume long range communication links over licensed spectrum with tight scheduling and staggering among different served XR users. Capacity per user may be an issue for this case, and correspondingly, an XR device may employ some sensors processing locally to reduce UL data volume (e.g., six degrees of freedom (6DOF) tracking, eye tracking for field of view (FOV) derivation, etc.), while the additional critical sensor/camera data from XR (e.g., UL) and the rendered video for the XR device (e.g., DL) may be compressed with a high compression factor (e.g., due to a limited link capacity per user). A sensor's data pre-processing on an XR device and video compression with a sufficiently high compression factor (e.g. the high profile of H264) have a high complexity, such as for the encoder side, and utilize extensive double data rate (DDR) usage for both Tx/Rx path video processing. Additionally, DDR can be a heavy power consumer itself. Further, due to photon-to-motion latency budgets and base station/gNB based split related latencies, Rx side processing on an XR device also includes asynchronous time wrapping (ATW) for last moment image alignment with the latest pose information. Other XR split approaches assume processing offloading with tethering to a relatively close companion device (e.g., a UE, a puck, etc.) or a processing split between the XR device, a companion UE, and a base station/gNB. From the XR device perspective, such a split assumes a similar processing load and locally covered functionality on the XR device side, but with a local short range communication link with the associated UE (such as a 5G NR sidelink or Wi-Fi™) which allows reductions specifically in modem-related power consumption.

Various aspects relate generally to reference signals (RSs) and XR devices. Some aspects more specifically relate to prediction based frequency domain (FD) quantizers for DL RS samples indication to support transmit (Tx) pre-equalization. In some examples, an XR device may predictively quantize a DL RS based on a prior sample of the DL RS, and provide, for a UE, a quantized representation of the DL reference signal and a set of controlled parameters. The XR device may also receive, from the UE, pre-cqualized data in accordance with a channel estimation associated with a reconstructed representation of the DL reference signal after quantization. Accordingly, aspects provide a low complexity CSI refresh procedure, at the receiver (Rx) side, based on a DL RS sampling and quantization scheme used for DL RS samples indication/reporting with low UL overhead for scenarios without channel reciprocity and optimized for a high signal-to-noise (SNR) regime. Additionally, aspects provide low-power/low-complexity ultra-wideband (UWB) based XR sidelink communications in 6G networks, and are applicable for any other power-/battery-limited device scenario, link type, band, application, and/or the like.

Particular aspects of the subject matter described in this disclosure can be implemented to realize one or more of the following potential advantages. In some examples, by providing a low complexity channel state information (CSI) refresh procedure relying on efficient DL RS sampling and quantization/compression scheme, the described techniques can be used to mediate arbitrary FD samples correlation and symbol timing offset (STO) associated with the DL RS samples. In some examples, by a shifting of the channel estimation and equalization related complexity and functionality from the XR device to its companion device/UE (e.g., the Tx side of the link), the described techniques can be used to reduce modem power consumption at the XR device (e.g., the Rx side of the modem/link). In some examples, by providing a DL RS samples indication with low UL overhead based on an efficient sampling and quantization scheme, the described techniques can be used to allow frequent CSI refresh (with a robust Tx pre-equalization-based scheme) for scenarios where a channel reciprocity assumption is not held. In some examples, by providing a negligible complexity CSI refresh procedures from the Rx side perspective (e.g., in a battery and complexity limited device), and by providing simplified XR modem hardware, the described techniques can be used to enable a smaller XR device battery size and lower XR device weight. In some examples, by providing an aggressive complexity off-loading from the XR device perspective (e.g., for modem complexity), the described techniques can be used to bring XR devices closer to an “XR as I/O device” platform.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

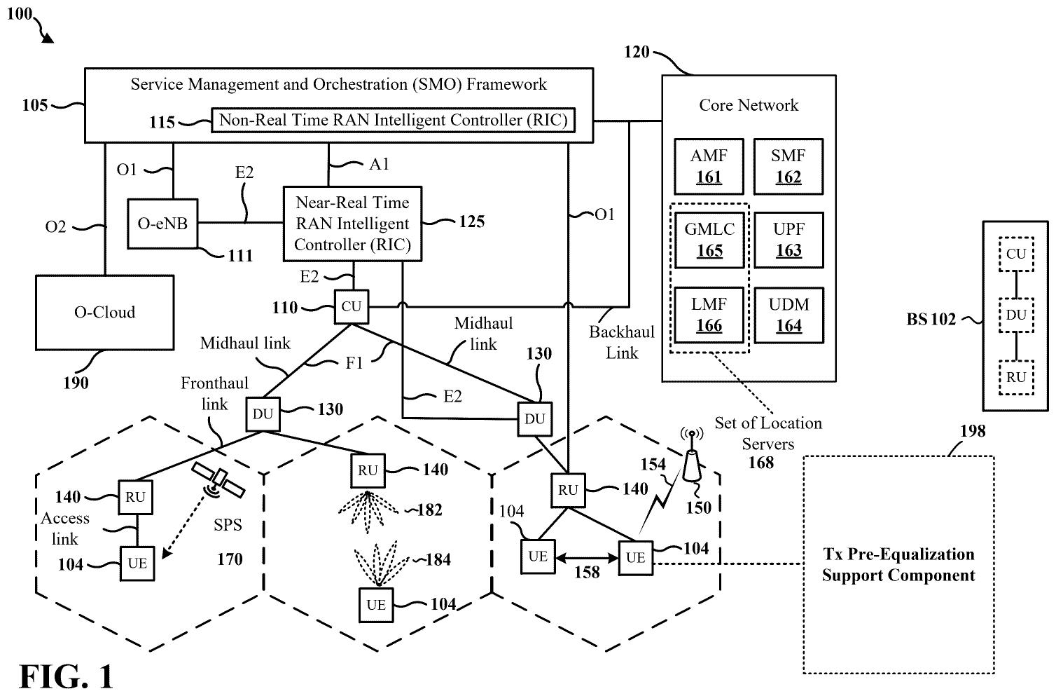

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a Tx pre-equalization support component 198 (“component 198”) that may be configured to predictively quantize a DL reference signal based on a prior sample of the DL reference signal. The component 198 may be configured to provide, for a UE, a quantized representation of the DL reference signal and a set of controlled parameters. The component 198 may be configured to receive, from the UE, pre-equalized data in accordance with a channel estimation associated with a reconstructed representation of the DL reference signal after quantization. The component 198 may be configured to reconstruct a representation of the quantized DL reference signal. The component 198 may be configured to receive, from an XR device, a quantized representation of a DL reference signal and a set of controlled parameters, where the quantized representation of the DL reference signal is based on a prior sample of the DL reference signal. The component 198 may be configured to estimate a channel associated with the DL reference signal. The component 198 may be configured to provide, for the XR device, pre-equalized data in accordance with a channel estimation from estimating the channel, where the channel estimation is associated with a reconstructed representation of the quantized DL reference signal. Accordingly, aspects provide a low complexity CSI refresh procedure, at the Rx side, based on a DL RS sampling and quantization scheme used for DL RS samples indication/reporting with low UL overhead for scenarios without channel reciprocity and optimized for a high SNR regime, and provide low-power/low-complexity UWB based XR sidelink communications in 6G networks, and are applicable for any other power-/battery-limited device scenario, link type, band, application, and/or the like.

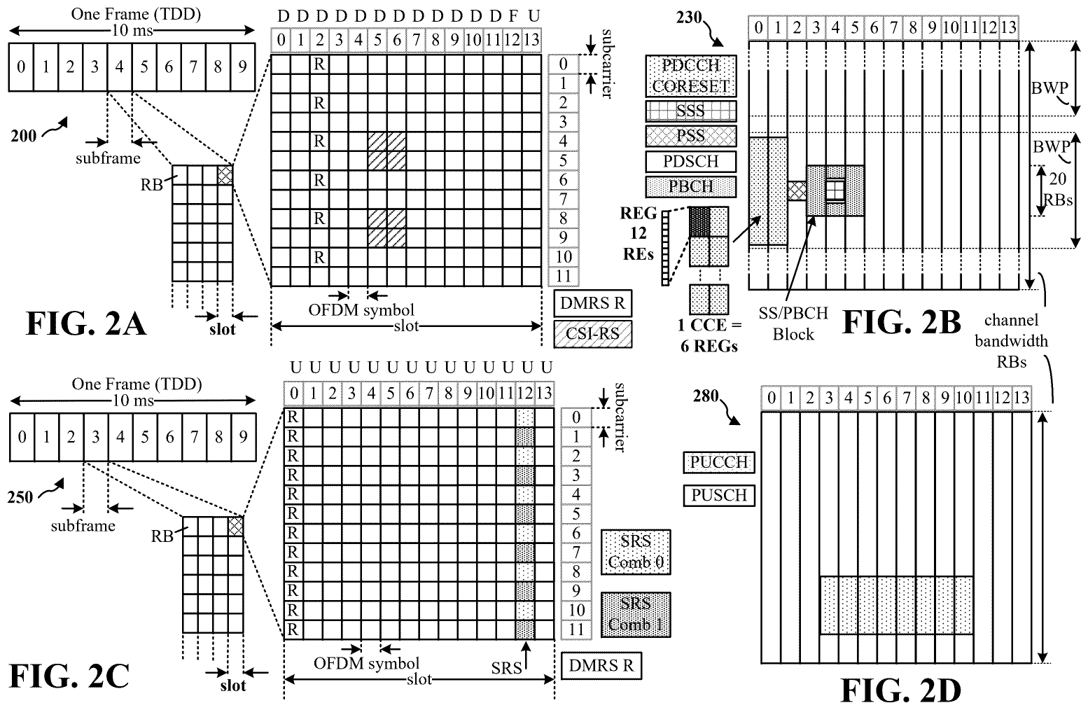

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

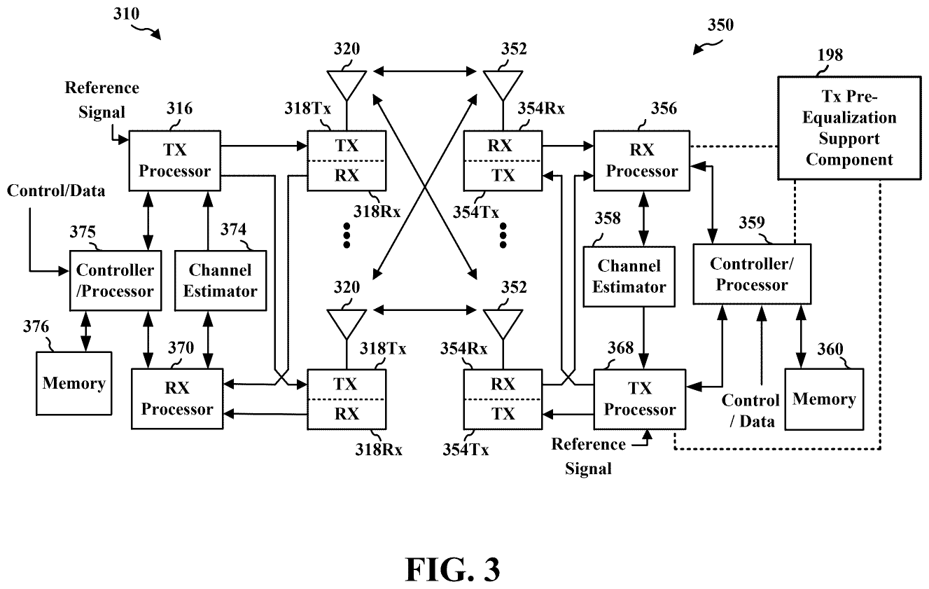

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

An XR device may communicate with a UE or a puck through a sidelink connection in 5G NR, 6G, and/or the like, to facilitate the usage of XR applications. XR traffic may include communications for VR, MR, AR, and/or the like. XR devices may include XR glasses, XR goggles, and/or other XR devices to provide a user with an XR experience. However, XR technology has many challenges and unsolved issues that limit readiness for massive commercialization and adoption. Among such issues are being light-weight appropriate for long-time use, e.g., “on the go,” ideally comparable with regular eye glasses which have a weight of approximately 30 g to 40 g, as XR devices may thus rely on a light weigh battery among the rest. Additionally, issues include limited processing complexity and power consumption to comply with available heat dissipation ability on the XR glasses/XR goggles/other XR devices (e.g., which may be much smaller than a typical UE for example, such as a smartphone, as it is proportional to the surface size of goggles/glasses, which is much smaller). For smart XR wearable goggles, the power consumption limit from the point of view of heat dissipation may be limited to only few watts. Likewise, reasonable power consumption to allow a light weight battery and a reasonable battery lifetime is also an issue. These issues are extremely challenging keeping in mind that heavy processing may be utilized to support many XR applications. A stand-alone XR product may not comply with the above “on the go” requirements and may be relevant only for some specific applications/static- and short-time usage scenarios, which allow to assume a higher form factor HMD usage. Because most application/scenario usage of high form factor HMD is not convenient, part of XR related processing may be shifted to a companion device with a split XR approach to reduce complexity on the XR device. A typical split XR approach moves most of the rendering related processing to a companion device, but many processing components are still left on the XR device for different E2E considerations (e.g., a photon-to-motion latency consideration, an XR-to-companion device wireless link capacity, communication link power consumption for long range links, etc.). And while existing split XR options significantly reduce power consumption on XR devices, the power consumption is still too high even for a less demanding video quality/user experience benchmark and less demanding applications such that this split scenario does not completely solve the technology-limiting factors mentioned above, and does not allow support of more demanding premium XR application (e.g., where frames per second (fps)≥120 Hz, where video formats ≥8 k, etc.). The split options above may assume long range communication links over licensed spectrum with tight scheduling and staggering among different served XR users. Capacity per user may be a primary issue for this case, and correspondingly, an XR device may employ some sensors processing locally to reduce UL data volume (e.g., 6DOF tracking, eye tracking for FOV derivation, etc.), while the additional critical sensor/camera data from XR (e.g., UL) and the rendered video for the XR device (e.g., DL) may be compressed with a high compression factor (e.g., due to a limited link capacity per user). A sensor's data pre-processing on an XR device and video compression with a sufficiently high compression factor (e.g. the high profile of H264) have a high complexity, such as for the encoder side, and utilize extensive DDR usage for both Tx/Rx path video processing. Additionally, DDR is a heavy power consumer itself. Further, due to photon-to-motion latency budgets and base station/gNB based split related latencies, Rx side processing on an XR device also includes ATW for last moment image alignment with the latest pose information. Other XR split approaches assume processing offloading with tethering to a relatively close companion device (e.g., a UE, a puck, etc.) or a processing split between the XR device, a companion UE, and a base station/gNB. From the XR device perspective, such a split assumes a similar processing load and locally covered functionality on the XR device side, but with a local short range communication link with the associated UE (such as a 5G NR sidelink or Wi-Fi™) which allows reductions specifically in modem-related power consumption.

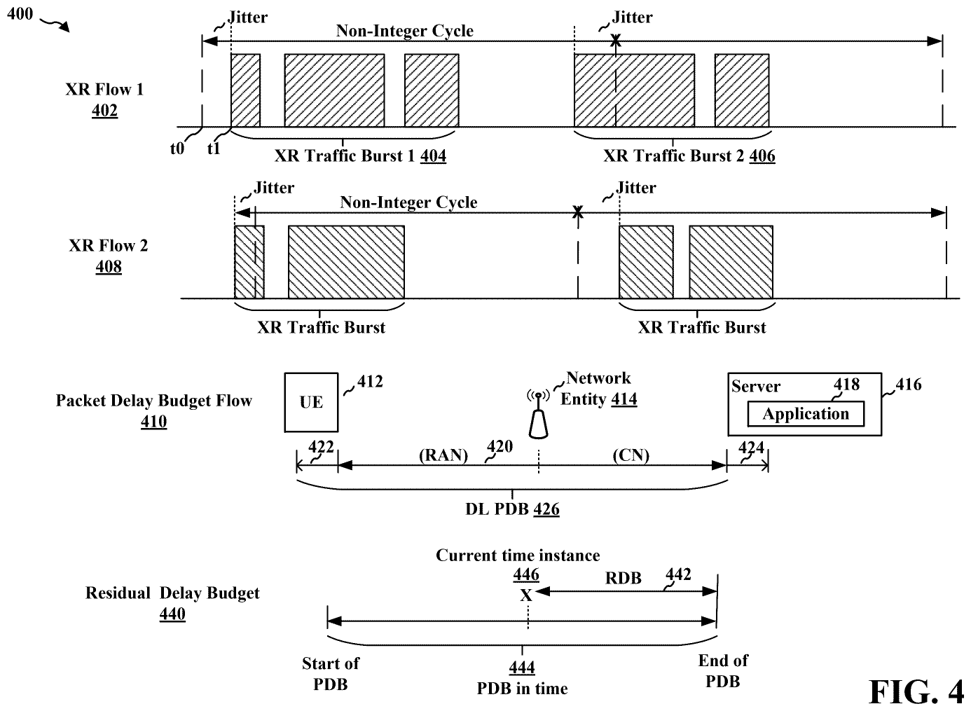

FIG. 4 is a diagram 400 illustrating example XR traffic. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset, a multi-projected environment that generates realistic images, sounds, and other sensations that simulate a user's physical presence in a virtual environment, and/or the like. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from-4 ms (earlier than expected arrival) to +4 ms (later than expected arrival). For instance, referring to the first XR flow 402, a UE may expect a first packet of the first XR traffic burst 404 to arrive at time to, but the first packet of the first XR traffic burst 404 arrives at a time t1, as shown.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame. However, the RDB at the UE may be unaccounted for in consideration of discarding packets. An example time diagram 440 shows a length of time corresponding to a PDB 444. At a particular point in time 446, the residual delay budget 442 is the remaining portion of the PDB 444.

An XR traffic overall PDB may include a portion to allow for communication delay of data (e2c PDB) between a UE and a computing device, e.g., a server, hosting an application, e.g., for XR, and a portion for additional time after the communication delay before the data is discarded, e.g., residual delay (e.g., RDB). For instance, the diagram 400 includes a packet delay budget flow 410. Packet delay budget flow 410 illustrates a UE 412, a network entity 414 (e.g., a base station or portion thereof), and a server 416 that hosts an application 418. In the illustrated aspect, a communication delay 420 is shown as including a RAN portion between the UE 412 and the network entity 414, as well as a CN portion between the network entity 414 and the server 416. The communication delay 420 may apply to both UL and DL communications.

Additionally, a residual delay 422 is shown at the UE 412 for DL communications and a residual delay 424 is shown at the server 416 for UL communications. The communication delay 420 and the residual delay 422 may make up an overall PDB for DL XR communications, e.g., DL PDB 426. Likewise, the communication delay 420 and the residual delay 424 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

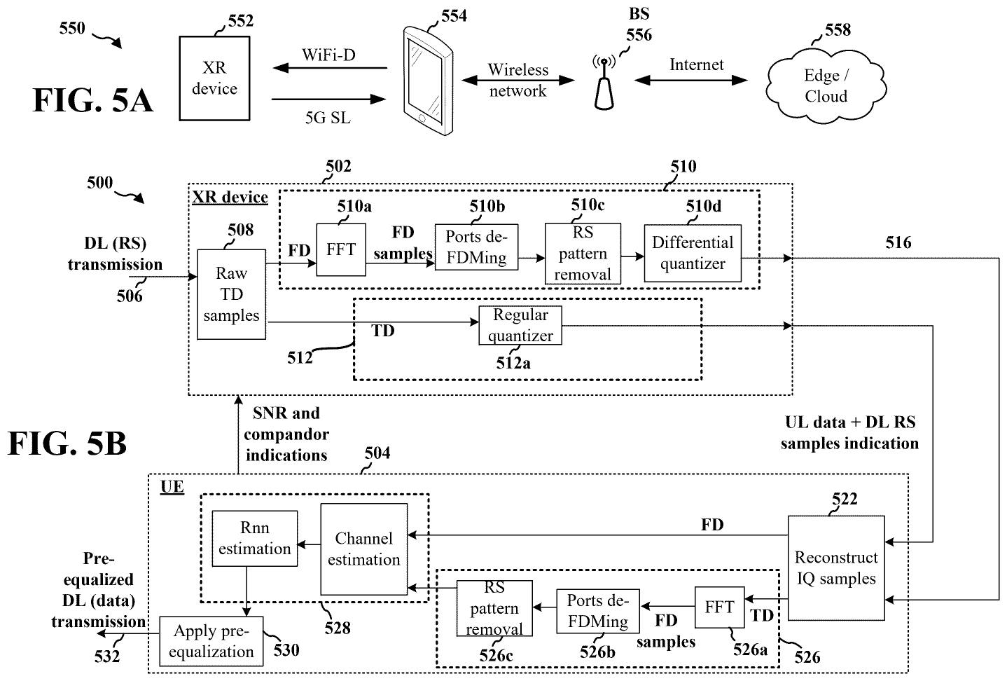

FIG. 5A is a diagram 550 illustrating an example of an XR traffic flow. Diagram 500 is shown in the context of an XR split approach between an XR device 552 and a companion UE 554 (e.g., a smartphone or a puck), where the companion UE 554 communicates over a wireless network with a network node (e.g., a base station 556, a gNB, etc.). The base station may communicate with an edge/cloud server 558 that hosts an XR application with which the XR device 552 may be associated.

In the example illustrated in diagram 550, processing offloading for the XR device 552 may be utilized. Such processing offloading may be accomplished via tethering to a relatively close companion device (e.g., the companion UE 554) or via a processing split between the XR device 552, the companion UE 554, and the base station 556. From the XR device 552 perspective, such a split assumes a similar processing load and locally covered functionality on the side of the XR device 552, but with a local short range communication link with the companion UE 554 (such as a 5G NR sidelink or Wi-Fi™) which allows reductions specifically in modem-related power consumption.

FIG. 5B is a block diagram 500 illustrating a DL RS processing flow between an XR device 502 (“XR”) and a companion device 504 (“UE”). The example DL RS processing flow includes DL RS sampling, quantization, and reconstruction. In the example of FIG. 5B, the XR device 502 receives a downlink RS transmission 506. The downlink RS transmission 506 may be output (e.g., provided) by the companion device 504. The XR device 502 performs a sampling procedure and obtains raw TD samples 508. As shown in FIG. 5B, the XR device 502 includes two example quantization flows based on whether the XR device 502 is configured to perform FD quantization or TD quantization. For example, the XR device 502 may perform an XR FD quantization flow 510 when configured to perform FD quantization on the raw TD samples 508. In another example, the XR device 502 may perform an XR TD quantization flow 512 when configured to perform TD quantization on the raw TD samples 508. The XR device 502 may then perform processing procedures on the output of the XR FD quantization flow 510 or the XR TD quantization flow 512 to obtain UL traffic 516. The example UL traffic 516 may include UL data and/or DL RS samples indication.

In the illustrated example of FIG. 5B, the XR FD quantization flow 510 includes performing FFT operations 510a on the raw TD samples 508 to obtain FD samples. The XR FD quantization flow 510 also includes performing DL RS ports demultiplexing procedures 510b (“Ports De-FDMing”), RS pattern removal procedures 510c, and differential quantizer procedures 510d. The differential quantizer procedures 510d may include differential Max-Lloyd quantization, which may be associated with a low complexity and, thus, facilitate a relatively low processing complexity at the XR device 502.

In examples in which the XR device 502 is configured to perform TD quantization, the XR device 502 may perform the XR TD quantization flow 512. As shown in FIG. 5B, the XR TD quantization flow 512 includes quantizer procedures 512a (“Regular Quantizer”). The quantizer procedures 512a may include performing Max-Lloyd quantization, which may be associated with a negligible processing complexing at the XR device 502.

At the companion device 504, the companion device 504 may obtain the UL traffic 516 from the XR device 502. The companion device 504 may perform processing procedures on the UL traffic 516. The companion device 504 may then perform one or more reconstruction procedures to obtain reconstructed samples 522 (“Reconstruct IQ samples”). The reconstructed samples 522 may include FD samples or TD samples. Similar to the XR device 502, the companion device 504 may perform one of two example quantization flows based on whether the companion device 504 is configured to perform FD quantization or TD quantization. In another example, the companion device 504 may perform a UE TD quantization flow 526 when configured to perform TD quantization on the reconstructed samples 522. The output of the UE the UE TD quantization flow 526 may be provided to estimation procedures 528. The estimation procedures 528 may include channel estimation procedures and Run estimation procedures. The companion device 504 may use the output of the estimation procedures 528 to apply pre-equalization procedures 530 and to generate DL traffic 532. The example DL traffic 532 may include a pre-equalized DL transmission. In some examples, the pre-equalized DL transmission may include data.

In other examples, the companion device 504 may be configured to perform TD quantization and, thus, may apply the UE TD quantization flow 526 to the reconstructed samples 522. In the illustrated example of FIG. 5B, the UE TD quantization flow 526 includes performing FFT operations 526a on the reconstructed samples 522 to obtain FD samples. The UE TD quantization flow 526 also includes performing ports demultiplexing procedures 526b (“Ports De-FDMing”), and RS pattern removal procedures 526c.

Although not shown in the illustrated example of FIG. 5B, the companion device 504 may provide the DL traffic 532 to the XR device 502 for presentment by the XR device 502.

Aspects herein provide a scheme of pre-equalization over UWB based sidelink for XR applications. To enable the pre-equalization, compressed DL reference signal samples, e.g., demodulation reference signal (DMRS) samples, are sent from the XR device to the UE. Aspects also provide compression algorithm related signaling that account for the channel correlation associated signaling to enable efficient quantization of the DMRSs. Aspects further provide for other parameters required for the compression, as well as UE-based and XR-based schemes. Aspects herein for prediction based FD quantizers for DL RS samples indication to support Tx pre-equalization provide a low complexity CSI refresh procedure, at the Rx side, based on a DL RS sampling and quantization scheme used for DL RS samples indication/reporting with low UL overhead for scenarios without channel reciprocity and optimized for a high SNR regime. Additionally, aspects provide low-power/low-complexity UWB based XR sidelink communications in wireless communication networks, such as 6G networks or others, and are applicable for any other power-/battery-limited device scenario, link type, band, application, and/or the like. Aspects mediate arbitrary FD samples correlation and STO associated with the DL RS samples by providing a low complexity CSI refresh procedure relying on efficient DL RS sampling and quantization/compression scheme. Aspects reduce modem power consumption at the XR device (e.g., the Rx side of the modem/link) by a shifting of the channel estimation and equalization related complexity and functionality from the XR device to its companion device/UE (e.g., the Tx side of the link). Aspects allow frequent CSI refresh (with a robust Tx pre-equalization-based scheme) for scenarios where a channel reciprocity assumption is not held by providing a DL RS samples indication with low UL overhead based on an efficient sampling and quantization scheme. Aspects enable a smaller XR device battery size and lower XR device weight by providing a negligible complexity CSI refresh procedures from the Rx side perspective (e.g., in a battery and complexity limited device), and by providing simplified XR modem hardware. Aspects bring XR devices closer to an “XR as I/O device” platform by providing an aggressive complexity off-loading from the XR device perspective (e.g., for modem complexity).

As for any link, including UWB based sidelink, there may be some residual synchronization loop errors such that XR device timing alignment is not ideal relative to a companion UE. Additionally, there may be some FFT window back off (BO) used for DL RS demodulation/conversion to the FD to avoid inter-symbol interference (ISI) impact from the previous OFDM symbol and to give more robustness to timing loop deviations. These factors altogether contribute a significant timing offset (TO) on non-pre-equalized DL RS signals that may be translated into a phase slope in the FD. As these non-pre-equalized DL RS samples may be used for Tx pre-equalization derivation on UE side, in aspects, the existing TO comprised in the effective DL channel may be captured by a Tx pre-equalization process (e.g., that relies on non-pre-equalized DL RS samples) to effectively eliminate the TO for Tx pre-equalized data transmission.

Aspects herein provide for avoidance of XR-local symbol timing offset (STO) estimations and corrections for DL data symbols. Actual STO may be captured by non-pre-equalized DL RS samples, and subsequently, Tx pre-equalization may effectively “eliminate” it for the XR receiver, e.g., Tx pre-equalized data may be obtained with effectively eliminated TO. The TO for XR synchronization loops management may also be estimated on the UE side based on non-pre-equalized DL RS samples signaled from the XR device for Tx pre-equalization evaluation (e.g., distributed among the UE and XR device synchronization loop for XR Rx can be suggested with loop measurements and management on the UE side and TO corrections indicated from time to time by the UE to the XR device, e.g., to be applied locally on XR device side). In some aspects, local XR device side TO measurements based on the same DL RS (e.g., non-pre-equalized) may be used to drive local timing loop management on XR device side.

Generally, any non-directional channel may be highly frequency selective, especially for indoor and UWB cases. Correspondingly, the FD response may generally have a limited correlation (e.g., for most consecutive REs, correlation may typically be high, but not for all of the consecutive REs). Aspects herein utilize a differential quantizer to quantize differences between consecutive samples that have a more limited distribution span compared to the input samples, when the samples have a high level of correlation (e.g., for a higher correlation, there may be a lower energy for the differential process). Lowering the value range of the differential samples to be quantized may provide for fewer representation bits to be utilized for holding quantization error below a desired threshold. That is, fewer bits may be used to signal DL RS samples. To minimize the variance of a differential process, aspects herein may use next sample prediction that takes in account the existing correlation for the addressed channel realization. With more accurate predictions, less energy may remain in the differential process to be quantized.

Aspects herein utilizing a FD differential quantizer for non-pre-equalized DL RS FD sample compression may account for the FD phase slope resulting from the existing STO to minimize the number of binary representation bits for differential signal re-quantization (and/or compression) with a minimum quantization/compression error floor. The presence of STO related phase slope may significantly reduce the correlation between all the consecutive REs such that a simple approximation of R(1)≈1 (e.g., an autocorrelation function) may no longer be valid, and the simplest form to generate a differential process (a differential operator) may not give acceptable results for this scenario. It may be desired to obtain a minimum variance process post-differentiation, and the existence of any STO slope may reduce FD response correlation, which may increase the differential process variance. In general, a TO may not be known, and for efficient elimination, the TO may be estimated and removed for improved compression. Moreover, FD correlation may also be channel dependent. Therefore, minimization of such differential process variance may be more efficient once the differential operator is replaced by a simple prediction-based differentiation that utilizes FD channel correlation knowledge. This correlation may capture any STO related phase slope in a robust way.

Accordingly, aspects herein address a prediction-based DPCM quantizer in the FD for DL RS re-quantization/compression. Aspects provide for quantization of the prediction error, rather than a regular subtraction result between two adjacent samples (e.g., as with a basic differentiator). Such a quantization scheme is more efficient and robust for high SNR regimes because the correlation of samples are exploited in an improved manner, and the original sample distribution (including the FD phase slope) is preserved with a minimum re-quantization error floor for a given binary representation per sample. Aspects herein may utilize a single-tap prediction that allows results for the addressed UWB scenario (e.g., <20 dB SNR with no more than 2 bits per in-phase and quadrature (I/Q) sampling). A higher-order prediction may also be utilized for DL RS sample compression in a wider general context and higher SNR regimes. Prediction coefficients may be based on the autocorrelation function of the samples. These coefficients may be known to both sidelink ends (e.g., both for re-quantization/compression and for the reconstruction process). Such coefficients may be evaluated either on the Rx side (e.g., at the XR device) or on the Tx side (e.g., at a UE). Evaluation at the Rx side may be based on current DL RS samples prior to compression and a signaling session these DL RS samples, and the samples may be signaled to the UE side (e.g., for reconstruction) along with the compressed samples. Evaluation at the Tx side may be based on previous DL RS samples (e.g., that were signaled by the XR device on previous sessions) and signaled by the UE to the XR device to be used in the next compression sessions. Aspects herein include both mechanisms. Additionally, aspects provide for SNR dependent quantization schemes for minimum complexity on the XR side, e.g., TD quantization for low SNR and FD quantization for mid/high SNR.

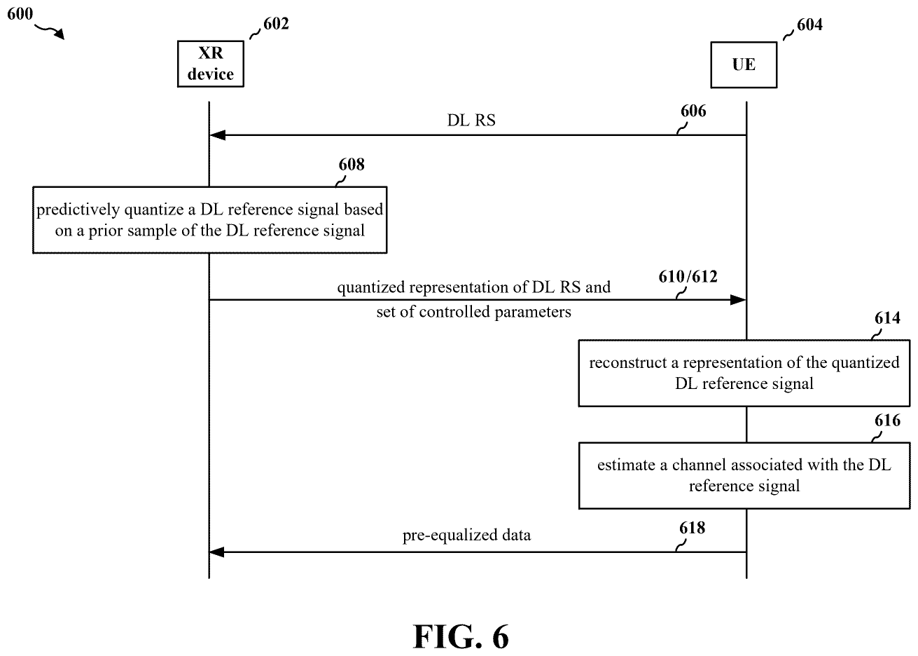

FIG. 6 is a call flow diagram 600 for wireless communications, in various aspects. Call flow diagram 600 illustrates prediction based FD quantizers for DL RS samples indication for an XR device 602 that communicates with a companion wireless device (e.g., a UE 604, by way of example, a puck, and/or the like) which may in turn communicate with a wireless network with one or more network nodes (e.g., a base station, such as a gNB or other type of base station or a DU(s), by way of example, as shown and described herein), in various aspects. Aspects described for the XR device 602 and/or the UE 604, and for XR devices/UEs herein, generally, may be performed may be performed by the XR device 602 and/or the UE 604 autonomously, in addition to, and/or in lieu of, the other of the XR device 602 and/or the UE 604. In aspects, communications between the XR device 602 and the UE 604 (e.g., a DL RS such as a DMRS, quantized representations, controlled parameters, pre-equalized data, etc.) may be communicated via various forms of sidelink communications, such as but not limited to, sidelink communications for 6G. In aspects described herein, an XR device, such as the XR device 602 may be, or may include one or more components as described herein for, a UE such as the UE 104 in FIG. 1 and/or the UE 350 in FIG. 3.

In the illustrated aspect, the XR device 602 may be configured to receive, and the UE 604 may be configured to transmit/provide, a DL reference signal 606 (DL RS). The XR device 602 may be configured to predictively quantize (at 608) the DL reference signal 606 based on a prior sample of the DL reference signal 606. In aspects, predictive quantization of the DL reference signal 606 may be based on FD sampling of the DL reference signal 606. The XR device 602 may be configured to generate a quantized representation 610 of the DL reference signal 606 based on the predictive quantization (at 608).

The XR device 602 may be configured to provide/transmit, and the UE 604 may be configured to receive, the quantized representation 610 of the DL reference signal 606 and a set of controlled parameters 612. The XR device 602 may be configured to provide/transmit the set of controlled parameters 612 in association with being configured to obtain the set of controlled parameters 612. In aspects, the set of controlled parameters 612 may be obtained by/at the XR device 602. The set of controlled parameters 612 may include at least one of a prediction coefficient, a prediction error variance, an applied received signal strength indicator (RSSI) scaling coefficient associated with the prior sample of the DL reference signal 606, a direct current bias removed from the DL reference signal 606 at the XR device 602, an initial sample of the DL reference signal 606, and/or the like. The set of controlled parameters 612 may further include compandor outputs, e.g., at the XR device 602, which may comprise coded unsigned bits. The set of controlled parameters 612 may be obtained by the XR device 602 through calculation, selection, identification, other forms of processing, communication with the UE 604, and/or the like. In aspects, to obtain the set of controlled parameters 612, the XR device 602 may be configured to obtain the prediction error variance at the XR device 602 in accordance with the prediction coefficient.

In aspects, to predictively quantize (at 608) the DL reference signal 606 based on the prior sample of the DL reference signal 606, the XR device 602 may be configured to receive, from the UE 604, control signaling. The control signaling may include at least one of a type of quantization, a number of bits for representation, a DL reference signal allocation period, an uplink resource allocation, a sampling rate (e.g., associated with TD and/or FD sampling), and/or the like. In such aspects, the XR device 602 may be configured to predictively quantize (at 608) the DL reference signal 606 further based on the control signaling. In aspects, to predictively quantize (at 608) the DL reference signal 606 based on the prior sample of the DL reference signal 606, the XR device 602 may be configured to generate the set of DL reference signal samples that are compressed, including to compress the set of DL reference signal samples in association with a DPCM quantizer, e.g., at the XR device 602. Accordingly, in aspects, the quantized representation 610 of the DL reference signal 606 may comprise/include the set of DL reference signal samples that are compressed.

As noted above, the XR device 602 may be configured to provide/transmit the set of controlled parameters 612 in association with being configured to obtain the set of controlled parameters 612. In aspects, the set of controlled parameters 612 may be obtained by the XR device 602, and may include at least one of an applied RSSI scaling coefficient associated with the prior sample of the DL reference signal 606, a direct current bias removed from the DL reference signal 606 at the XR device 602, an initial sample of the DL reference signal 606, and/or the like. In such aspects, the XR device 602 may be configured to obtain the set of controlled parameters 612, including to receive, from the UE 604, at least one of a prediction coefficient or a prediction error variance. The prediction coefficient and/or the prediction error variance may be associated with the prior sample of the DL reference signal 606. The set of controlled parameters may further include compandor outputs, e.g., at the XR device 602, which may comprise coded unsigned bits. The XR device 602 may be configured to predictively quantize (at 608) the DL reference signal 606 further based on at least one of the prediction coefficient or the prediction error variance. In such aspects, the XR device 602 may be configured to predictively quantize (at 608) the DL reference signal 606, including to receive, from the UE 604, control signaling that includes at least one of a type of quantization, a number of bits for representation, a DL reference signal allocation period, an UL resource allocation, a sampling rate, and/or the like, and the XR device 602 may be configured to predictively quantize (at 608) the DL reference signal (606) further based on the control signaling.

The UE 604 may be configured to reconstruct (at 614) a representation of the quantized DL reference signal. In aspects, the UE 604 may be configured to reconstruct (at 614) the representation of the quantized DL reference signal based on the set of controlled parameters 612. In some aspects, the XR device 602 may be configured to reconstruct (at 614) the representation of the quantized DL reference signal based on the set of controlled parameters 612, and to provide a reconstructed representation of the DL reference signal 606 after quantization to the UE 604 (e.g., for channel estimation and Tx pre-equalization). The UE 604 may also be configured to estimate (at 616) a channel associated with the DL reference signal 606. In aspects, the UE 604 may be configured to estimate (at 616) the channel associated with the DL reference signal 606 based on the representation of the quantized DL reference signal and/or based on the reconstructed representation of the DL reference signal 606 after quantization. The UE 604 may be configured to perform Tx pre-equalization, e.g., for pre-equalized data 618, accordingly.

The XR device 602 may be configured to receive, and the UE 604 may be configured to transmit/provide, the pre-equalized data 618 in accordance with a channel estimation associated with a reconstructed representation of the DL reference signal 606 after quantization. In aspects, the reconstructed representation of the DL reference signal 606 after quantization may be based on the set of controlled parameters 612 and/or the estimate (at 616) of the channel. The pre-equalized data 618 may be of, or otherwise associated with, an XR application with which the XR device 602 is associated.

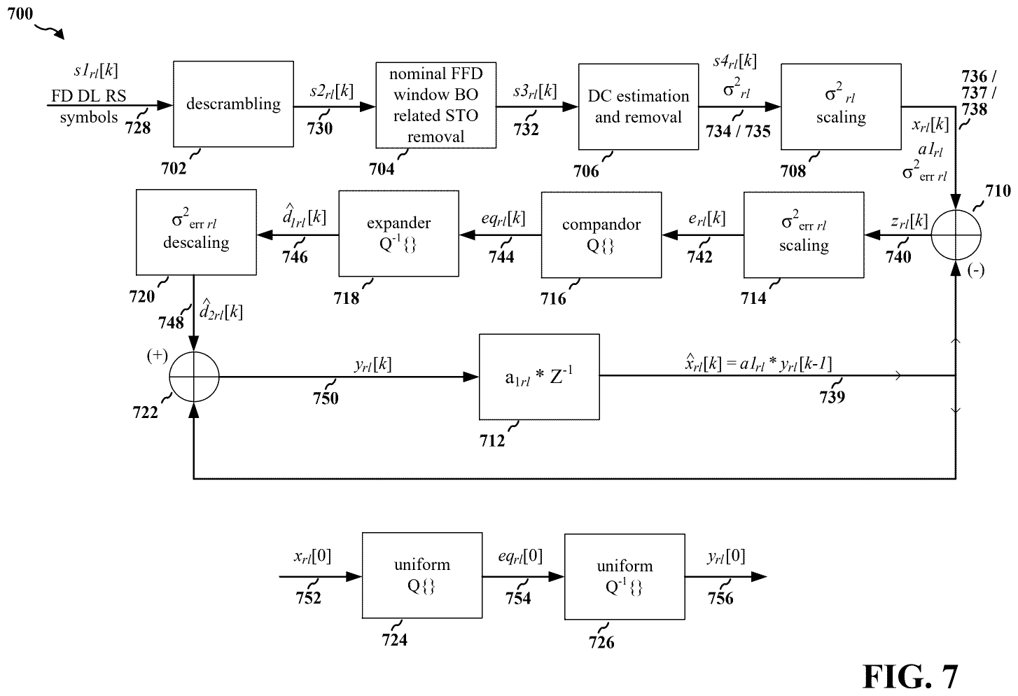

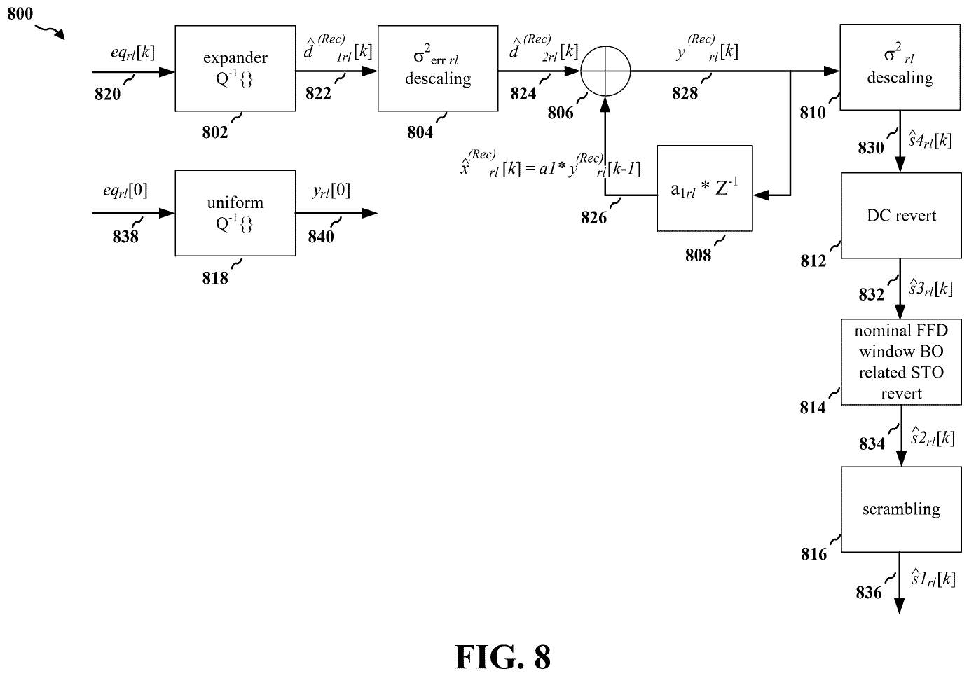

Examples of DPCM prediction-based quantization and compression/reconstruction for sampling and pre-equalization are provided in the context of FIGS. 7, 8, described below. As noted above, aspects provide for complexity minimization on the XR device side, and also provide for efficient DL RS quantization/compression to achieve a more reasonable/reduced UL overhead associated with DL RS sample signaling from the XR device (e.g., the Rx side) to a UE (e.g., the Tx side) for evaluation of Tx pre-equalization in scenarios where a channel reciprocity assumption is not held. In some cases, such as for mid/high SNR scenarios, a differential Max-Lloyd non-uniform quantizer may be used for FD samples to achieve optimal compression results by exploiting FD correlation of samples. However, using a simple differential quantizer without taking in account STO/time uncertainty existence and the level of correlation between FD samples may distort the differential sample distribution (e.g., especially for high SNR regime) such that this distribution will not match the assumed Max-Lloyd quantizer derivation Gaussian distribution. The quantization/compression error may increase, and as a result, the DL RS sample indication in the UL may experience a significantly increased error floor/distortion.

Phase slope in the FD that is related to some STO may result in a decreased FD correlation and may increase sensitivity in accounting for the actual FD correlation in general. This issue may be addressed by the aspects herein in different ways to improve the quantization/compression process. In one example, a differential quantizer may be used with the addition of STO slope estimation, and its removal, before application of the differential quantizer. For instance, the slope coefficient/STO may be signaled to the UE side (Tx) to be re-applied at the end of the sample reconstruction process), with the XR device side handling this added complexity. In another example, a full DPCM quantizer that is based on a single tap prediction (or multi-tap prediction for a high SNR regime) may be utilized. While the prediction coefficient(s) for a DPCM quantizer in the FD may be based on the FD sample correlation function, which may be measured for a DL RS before a quantization/compression session, the FD phase slope/STO estimation may be explicitly absorbed in the correlation coefficient. Therefore, according to aspects, using a DPCM-based quantizer applies both STO estimation and removal simultaneously by applying the correlation coefficient in the prediction process.

The simple differential quantizer noted above for mid/low SNR regimes may normalizes the prediction error/difference operation result seeks to achieve a deterministic normalized variance for Max-Lloyd quantization. This normalization may be based on an assumption that quantization error is negligible. Yet, if there is a significant reduction in FD correlation for a specific channel realization, or due to some phase slope existence in general, quantization error in such a case (e.g., with the simple quantizer variant) may increase and may not remain negligible for a high SNR regime. Thus, this normalization may not retain a desired accuracy.

This in turn may further increase the quantization error, and as a result, implementations of this simpler mechanism may be worse in terms of the resulting quantization error floor for a high SNR regime. The prediction based quantizer may consider both an arbitrary FD correlation in general, as well as the existing phase slope corresponding thereto. Both the prediction coefficient and the prediction error scaler (e.g., Max-Lloyd quantizer input variance scaling) may be evaluated from the 1-lag normalized FD correlation coefficient of the samples. A comparison between both of these mechanisms, constrained to the same binary representation per sample (e.g., 1 and 2 bits per I/Q) shows that for a high/higher SNR, a DPCM based quantizer allows for better E2E throughput results with Tx pre-equalized waveforms (e.g., allows for less Tx pre-equalization mismatches due to a lower quantization error for DL RS samples). Furthermore, in the context of the efficient quantization scheme adaptation provided by aspects herein, a 1-bit TD quantization for a low SNR regime may be utilized for such a quantization scheme.

FIGS. 7 and 8, described below, provide various relevant expressions associated with DPCM prediction-based quantization for sampling and pre-equalization for compression on the XR device side and for reconstruction on the UE side. To avoid a significant FD correlation reduction (e.g., which increases quantization error) due to a high STO, the deterministic STO component related to the FFT window BO may be removed before quantization and returned after sample reconstruction on the UE side. The FFT BO configuration may be signaled by the XR device to the UE or by the UE to the XR device to maintain alignment. Normalizing the distribution may be performed by calculating the signal variance/power, and therefore, the mean/direct current (DC) term may be removed.

FIG. 7 is a diagram 700 illustrating an example of DPCM prediction-based quantization and compression for sampling and pre-equalization, in various aspects. The DPCM prediction-based quantization and compression for sampling and pre-equalization shown in diagram 700 may be performed by an XR device (e.g., the XR device 602 in FIG. 6), and the diagram 700 may be an aspect of the call flow diagram 600 in FIG. 6. In aspects illustrated for the diagram 700, k may refer to a FD index, r may refer to an Rx antenna index, and I may refer to a layer/port index.

DPCM prediction-based quantization and compression for sampling and pre-equalization may be based on a DL reference signal, such as DL reference signal 606 in FIG. 6. In aspects, as shown, an XR device may be configured to perform descrambling (at 702) of DL RS symbols 728 in the FD (e.g., separated by antenna/port as: s₁_{ᵣₗ}[k]) that are received from a UE in association with a DL RS to generate descrambled samples 730: s₂_{ᵣₗ}[k]. The BO may be pre-configured by a UE for the XR device or may signaled from the XR device to the UE (e.g., signaled once assuming it is not changed). The UE and the XR device sides may be aligned on this BO assumption. The XR device may be configured to remove (at 704) the FFT BO related to the STO, and to generate samples 732 (s₃_{ᵣₗ}[k]) from which the DC component may be estimated and removed (at 706) to generate samples 734 (s₃_{ᵣₗ}[k]) and calculate, from a DL RS RSSI (e.g., after FFT BO and DC removal), an applied RSSI scaling coefficient 735 represented as:

$${σ}_{rl}^{2} {=}^{Δ} \frac{1}{N} {\sum }_{k = 0}^{N - 1} {\vert {s}_{{4}_{rl}} [ k ] \vert}^{2} .$$

The XR device may be configured to scale (at 708) the samples 734 in associated with the applied RSSI scaling coefficient 735 to generate a scaled signal

$$736 ( {x}_{rl} [ k ] = Δ \frac{{s}_{{4}_{rl}} [ k ]}{{σ}_{rl}} ; {R}_{x} [ 0 ] = \frac{1}{N} {\sum }_{k = 0}^{N - 1} {\vert {x}_{rl} [ k ] \vert}^{2} = 1 ) ,$$

a prediction coefficient 737 (a₁_{ᵣₗ}), and a prediction error variance

$$738 ( {σ}_{{err}_{rl}}^{2} = … = 1 - {\vert {a}_{{1}_{rl}} \vert}^{2} ( 1 + {σ}_{{q}_{rl}}^{2} ) ) .$$

The XR device may be configured subtract, via a subtractor 710, a signal prediction 739 (\hat{x}ᵣₗ[k]=a₁_{ᵣₗ}yᵣₗ[k−1]) (e.g., generated by a predictor 712 (a₁_{ᵣₗ}*Z⁻¹)) from the scaled signal 736 to generate a prediction error 740 (zᵣₗ[k]=xᵣₗ[k]−\hat{x}ᵣₗ[k]=errᵣₗ[k]).

The XR device may be configured to scale (at 714) the prediction error 740 to generate a scaled prediction error

$$742 ( {e}_{rl} [ k ] = \frac{{z}_{rl} [ k ]}{{σ}_{{err}_{rl}}} = \frac{{x}_{rl} [ k ] - {\hat{x}}_{rl} [ k ]}{{σ}_{{err}_{rl}}} ) ,$$

and in some aspects to generate a correlation coefficient, which may be provided to a compandor 716 to generate a compandor output as a set of compressed DL RS samples, or as a quantized representation 744 of the DL reference signal: eqᵣₗ[k]=({eᵣₗ[k]}, having a number of samples k after a compression session. The XR device may be configured to provide the quantized representation 744 of the DL reference signal to an expander 718 to generate an expander output 746: \hat{d}₁_{ᵣₗ}[k]=\hat{Q}⁻¹{eqᵣₗ[k]}, which may be further descaled (at 720) to generate a descaled quantized prediction error 748: \hat{d}₂_{ᵣₗ}[k]=σₑᵣᵣ_{ᵣₗ}\hat{d}₁_{ᵣₗ}[k]. The descaled quantized prediction error 748 may be combined, e.g., via an adder 722, with the signal prediction 739 to generate a reconstructed scaled signal 750: yᵣₗ[k] [symbol] a₁_{ᵣₗ}yᵣₗ[k−1]+\hat{d}₂_{ᵣₗ}[k].

Thus, for the prediction coefficient 737 (a₁_{ᵣₗ}) as associated with a correlation coefficient

$$( {R}_{{x}_{rl}} [ 1 ] = \frac{1}{N} {\sum }_{k = 0}^{N - 1} {x}_{rl} [ k ] {x}_{rl}^{*} [ k - 1 ] ) ,$$

and based on a Max-Lloyd quantizer error of

$${q}_{{ML}_{rl}} [ k ] = Δ {\hat{d}}_{{1}_{rl}} [ k ] - {e}_{rl} [ k ] {\underbrace{\approx }}_{CN ( 0 , 1 )} 2.721 \cdot {2}^{- 2 {q}_{len}} \cdot \frac{1}{2}$$

and a quantization/reconstruction error of qᵣₗ[k] [symbol] yᵣₗ[k]−xᵣₗ[k]= . . . =errᵣₗq_{ML}[k], the prediction coefficient 737 can be shown as

$${a}_{{1}_{rl}} = {arg}_{a} \{ min {σ}_{{err}_{rl}}^{2} ( a ) \} = … = \frac{{R}_{{x}_{rl}} [ 1 ]}{1 + {σ}_{q}^{2}} .$$

The reconstructed scaled signal 750 (yᵣₗ[k] [symbol] a₁_{ᵣₗ}yᵣₗ[k−1]+\hat{d}₂_{ᵣₗ}[k]) may be provided to the predictor 712 (a₁_{ᵣₗ}*Z⁻¹) to generate a next prediction of the signal prediction 739. That is, the predictor 712 may utilize a previous sample of the DL RS to generate a given signal prediction for the signal prediction 739 during a session.

The XR device may also be configured to apply a uniform quantization (at 724) to a first bit 752 (xᵣₗ[0]) of the scaled signal

$$736 ( {x}_{rl} [ k ] {=}^{Δ} \frac{{s}_{{4}_{rl}} [ k ]}{{σ}_{rl}} ; {R}_{x} [ 0 ] = \frac{1}{N} {\sum }_{k = 0}^{N - 1} {\vert {x}_{rl} [ k ] \vert}^{2} = 1 )$$

to generate a first sample, e.g., an initial sample 754 (eqᵣₗ[0]) of the DL reference signal, from which an inverse uniform quantization (at 726) may be applied to generate a first bit 756 (yᵣₗ[0]) of the reconstructed scaled signal 750.

In aspects, the XR device may be configured to transmit/provide, e.g., via sidelink, for the UE (e.g., the reconstructing side), the compressed DL RS samples (eqᵣₗ[k]) (e.g., the quantized representation 744 of the DL reference signal) and a set of controlled parameters. In aspects, the set of controlled parameters may include one or more of the applied RSSI scaling coefficient

$$735 ( {σ}_{rl}^{2} ) ,$$

the estimated DC bias (e.g., at 706) removed from the DL RS, the prediction error variance

$$738 ( {σ}_{{err}_{rl}}^{2} ) ,$$

the prediction coefficient 737 (a₁_{ᵣₗ}), the first sample 754 (eqᵣₗ[0]) (e.g., for predictor 712 initiation), and/or the like.

Accordingly, the aspects herein provide for minimized compression complexity and minimized overhead in UL signaling as the operations described above have almost no complexity and are associated with simple calculations.

FIG. 8 is a diagram 800 illustrating an example of DPCM reconstruction for sampling and pre-equalization, in various aspects. The DPCM reconstruction for sampling and pre-equalization shown in diagram 800 may be performed by an XR device (e.g., the XR device 602 in FIG. 6) or by a UE (e.g., the UE 604 in FIG. 6), and the diagram 800 may be an aspect of the call flow diagram 600 in FIG. 6. In aspects illustrated for the diagram 800, k may refer to a FD index, r may refer to an Rx antenna index, and l may refer to a layer/port index.

As referenced above with respect to FIG. 7, an XR device may be configured to provide compressed DL RS samples (eqᵣₗ[k]) (e.g., a quantized representation 820 of the DL reference signal, which may be a compandor output of coded unsigned bits) and a set of controlled parameters, e.g., via sidelink, to a UE for reconstruction. In some aspects, the reconstruction may be performed by the XR device. With reference to FIG. 7, the set of controlled parameters may include one or more of the applied RSSI scaling coefficient

$$735 ( {σ}_{rl}^{2} ) ,$$

the estimated DC Dias (e.g., at 706) removed from the DL RS, the prediction error variance

$$738 ( {σ}_{{err}_{rl}}^{2} ) ,$$

the prediction coefficient 737 (a₁_{ᵣₗ}), the first sample 754 (eqᵣₗ[0]) (e.g., for predictor initiation), and/or the like.

The quantized representation 820 of the DL reference signal may be provided to a reconstructed expander 802 to generate expanded samples

$$822 ( {\hat{d}}_{1}^{( Rec )} {}_{rl} [ k ] = {\hat{Q}}^{- 1} \{ {eq}_{rl} [ k ] \} ) ,$$

which may be descaled (at 804) in association with the prediction error variance

$$738 ( {σ}_{{err}_{rl}}^{2} ) ,$$

to generate a descaled reconstructed quantized prediction error

$$824 ( {\hat{d}}_{2}^{( Rec )} {}_{rl} [ k ] = {σ}_{{err}_{rl}} {\hat{d}}_{1}^{( Rec )} {}_{rl} [ k ] ) .$$

The descaled reconstructed quantized prediction error 824 may be combined, via an adder 806, with a reconstructed scaled signal prediction 826 (\hat{x}^{(Rec)}ᵣₗ[k]=a₁_{ᵣₗ}yᵣₗ[k−1]) to generate a reconstructed scaled signal

$$828 ( {y}_{rl}^{( Rec )} [ k ] {=}^{Δ} {a}_{{1}_{rl}} {y}_{rl}^{( Rec )} [ k - 1 ] + {\hat{d}}^{( Rec )} {}_{{2}_{rl}} [ k ] ) .$$

A predictor 808 (a₁_{ᵣₗ}*Z⁻¹), e.g., based on the prediction coefficient 737 (a₁_{ᵣₗ}), may be configured to take the reconstructed scaled signal

$$828 ( {y}_{rl}^{( Rec )} [ k ] {=}^{Δ} {a}_{{1}_{rl}} {y}_{rl}^{( Rec )} [ k - 1 ] + {\hat{d}}^{( Rec )} {}_{{2}_{rl}} [ k ] )$$

as an input, and to provide the reconstructed scaled signal prediction 826 (\hat{x}^{(Rec)}ᵣₗ[k]=a₁_{ᵣₗ}yᵣₗ[k−1]) as an output.

The reconstructed scaled signal:

$$828 ( {y}_{rl}^{( Rec )} [ k ] {=}^{Δ} {a}_{{1}_{rl}} {y}_{rl}^{( Rec )} [ k - 1 ] + {\hat{d}}^{( Rec )} {}_{{2}_{rl}} [ k ] )$$

may also be descaled (at 810), e.g., in association with the applied RSSI scaling coefficient

$$735 ( {σ}_{rl}^{2} ) ,$$

to generate a reconstructed descaled signal

$$830 ( {\hat{s}}_{{4}_{rl}}^{( Rec )} [ k ] = {σ}_{rl} {y}_{rl}^{( Rec )} [ k ] ) .$$

The estimated DC bias may be reverted (at 812) for the reconstructed descaled signal 830 to generate a reconstructed DC reverted signal

$$832 ( {\hat{s}}_{{3}_{rl}}^{( Rec )} [ k ] ) ,$$

from which the FFT BO related to the STO may be reverted (at 814) to generate a reconstructed DC and BO reverted signal

$$834 ( {\hat{s}}_{{2}_{rl}}^{( Rec )} [ k ] ) .$$

The reconstructed DC and BO reverted signal 834 may be re-scrambled (at 816) to generate a reconstructed descaled signal

$$836 ( {\hat{s}}_{{1}_{rl}}^{( Rec )} [ k ] )$$

atter DC/FFT BO revert and re-scrambling.

A first sample 838 (e.g., which may correspond to the first sample 754 (eqᵣₗ[0]) in FIG. 7) may be utilized for predictor 808 initiation). The first sample may be applied an inverse uniform quantization (at 818) to generate a first bit 840 (yᵣₗ[0]) for predictor 808 initiation.

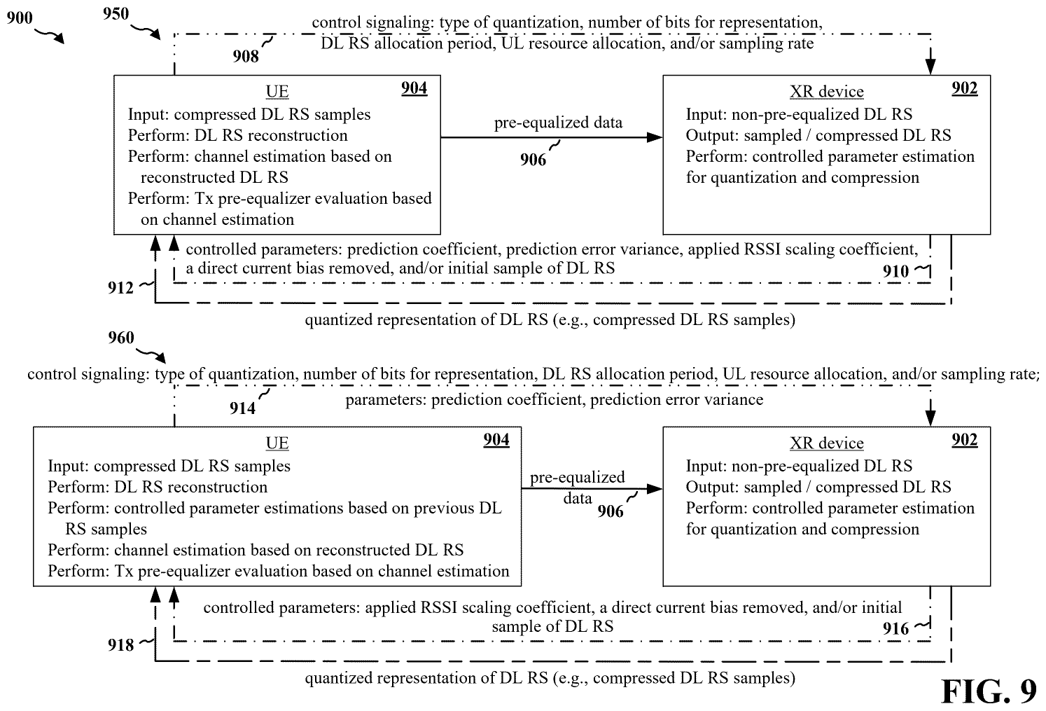

FIG. 9 is a diagram 900 illustrating examples of DPCM prediction-based quantization with correlation coefficient evaluation for sampling and pre-equalization, in various aspects. Diagram 900 is shown for an XR device 902 and a UE 904 that may communicate via sidelink communications, by way of example. A configuration 950 is shown for XR device side evaluation of DPCM-based quantization parameters (e.g., including a set of controlled parameters) and UE-side reconstruction, and a configuration 960 is shown for UE-side evaluation of a prediction coefficient(s) based on previous DL RS samples.

The aspects herein enable a DPCM prediction-based quantizer to achieve significantly better performance for high SNR regimes. As noted herein, both sidelink ends may be aligned on the correlation coefficient(s) of used samples (e.g., in DPCM prediction used for sample compression and decompression/reconstruction), as well as the prediction error normalization/scaling factor for both compression and decompression.

In the configuration 950, the UE 904 may be configured to provide control signaling 908 to the XR device 902. In aspects, the control signaling 908 may include a type of quantization, a number of bits for representation, a DL RS allocation period, an UL resource allocation, and/or a sampling rate (e.g., for TD and/or FD sampling). The XR device 902 may be configured to evaluate all DPCM-based quantization parameters and to signal such quantization parameters along with the quantized samples DL RS to the UE 904 to use it for reconstruction. For instance, the XR device 902 may be configured to provide/transmit, and the UE 904 may be configured to receive, a quantized representation 912 of a DL RS and a set of controlled parameters 910. The quantized representation 912 may comprise compressed DL RS samples, and the set of controlled parameters 910 may include one or more of a prediction coefficient, a prediction error variance, an applied RSSI scaling coefficient, a direct current bias removed, and/or initial sample of DL RS. In aspects, the prediction error coefficient may be immediately available without calculations by the XR device, e.g., based on the prediction coefficient

$${σ}_{{err}_{rl}}^{2} = 1 - {\vert {a}_{{1}_{rl}} \vert}^{2} ( 1 + {σ}_{q}^{2} ) .$$

The remaining parameters utilized for DL RS sample compression may be evaluated by the XR device 902 locally and may be signaled to the UE side per-session.

That is, the XR device 902 may be configured to take a non-pre-equalized DL RS as an input, to provide sampled/compressed DL RS as an output, and to perform controlled parameter estimation for quantization and compression. The UE 904 may be configured to take compressed DL RS samples as an input, and to perform one or more of DL RS reconstruction, channel estimation based on the reconstructed DL RS, and/or Tx pre-equalizer evaluation based on the channel estimation. Accordingly, pre-equalized data 906 may be provided/transmitted by the UE 904 and received by the XR device 902.

The configuration 950 may include more computation at the XR device and, therefore, more complexity. However, the prediction error may be minimized due to a match between the evaluated/used parameters (e.g., evaluated per session, per Tx port index, per Rx antenna index) and the DL RS samples that are being compressed at the XR device. Additionally, the configuration 960 provides an improved quantization error floor for a low CSI refresh rate/longer period, as channel correlation may change over time or may be different for different channel realizations/refresh sessions if the controlled parameters are not evaluated for/coupled to every DL RS sampling and compression session.

In the configuration 960, the UE 904 may be configured to evaluate the prediction coefficient(s) estimations (e.g., for a prediction coefficient and a prediction error variance) on the UE side based on the previous DL RS samples. The UE 904 may be configured to indicate the prediction coefficient(s) to the XR device via DL control signaling (e.g., from time-to-time, or before each CSI refresh iteration). In such aspects, for the first DL RS quantization prediction, a tap=1 may be used.

The UE 904 may be configured to provide control signaling and parameters 914 to the XR device 902. In aspects, the control signaling of the control signaling and parameters 914 may include a type of quantization, a number of bits for representation, a DL RS allocation period, an UL resource allocation, and/or a sampling rate (e.g., for TD and/or FD sampling), and the parameters of the control signaling and parameters 914 may include estimations of the prediction coefficient and the prediction error variance. The XR device 902 may be configured to evaluate all DPCM-based quantization parameters, except for the prediction coefficient and the prediction error variance, and to signal such quantization parameters along with the quantized samples DL RS to the UE 904 to use it for reconstruction. For instance, the XR device 902 may be configured to provide/transmit, and the UE 904 may be configured to receive, a quantized representation 918 of a DL RS and a set of controlled parameters 916 The quantized representation 918 may comprise compressed DL RS samples, and the set of controlled parameters 916 may include one or more of an applied RSSI scaling coefficient, a direct current bias removed, and/or initial sample of DL RS. These parameters utilized for DL RS sample compression may be evaluated by the XR device 902 locally and may be signaled to the UE side per-session.

That is, the XR device 902 may be configured to take a non-pre-equalized DL RS as an input, to provide sampled/compressed DL RS as an output, and to perform controlled parameter estimation for quantization and compression. The UE 904 may be configured to take compressed DL RS samples as an input, and to perform one or more of DL RS reconstruction, controlled parameter estimations (e.g., for a prediction coefficient and a prediction error variance) based on previous DL RS samples, channel estimation based on the reconstructed DL RS, and/or Tx pre-equalizer evaluation based on the channel estimation. Accordingly, pre-equalized data 906 may be provided/transmitted by the UE 904 and received by the XR device 902.

The configuration 960 may provide minimal complexity related to DL RS sampling and compression at the XR device 902 (e.g., fewer evaluations), however, using prediction coefficients evaluated at the UE 904 based on previous DL RS sample indications may create some delay/mismatch between the used prediction coefficient and the coefficient that is optimally aligned with the currently sampled DL RS. This kind of channel aging in terms of sample correlation and prediction coefficients may depend on the CSI refresh period, and may increase for longer refresh periods. The configuration 960 provides improvements for a high CSI refresh rate/shorter period, and therefore, channel correlation may be assumed as unchanged over time. Accordingly, using a prediction coefficient with a minor delay over time may not impact performance and/or accuracy in such scenarios.

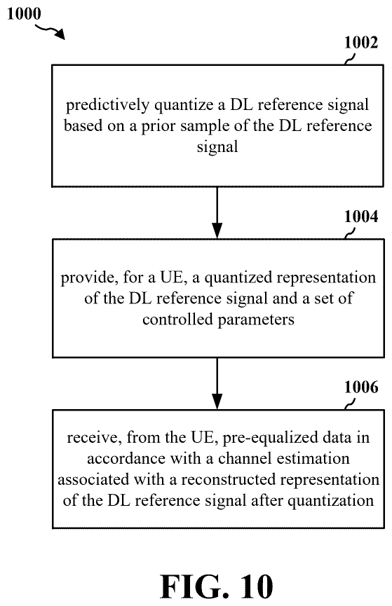

FIG. 10 is a flowchart 1000 of a method of wireless communication. The method may be performed by an XR device (e.g., the XR device 502, 602, 702, 902; the apparatus 1104). The method may be for prediction based FD quantizers for DL RS samples indication to support Tx pre-equalization. The method may provide for enabling a UE and a network to cooperatively choose the best set of antennas based on SRS, such as via UE capability reporting, SRS configuration for AS, and AS operations, and thus provide closed-loop UL AS support.

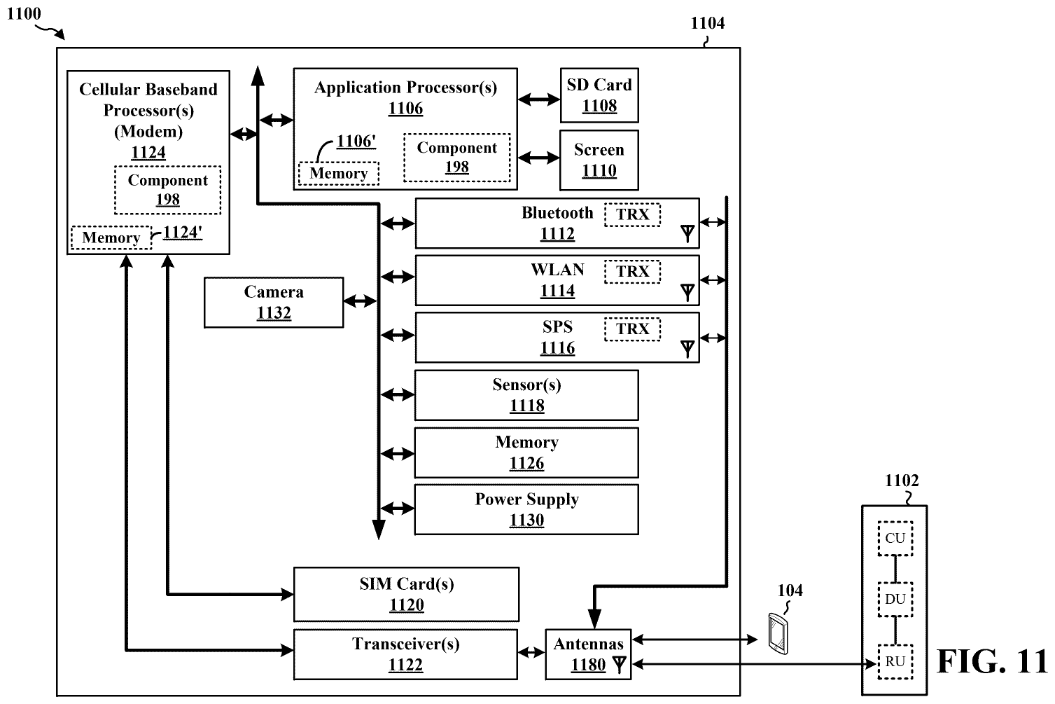

At 1002, the XR device predictively quantizes a DL reference signal based on a prior sample of the DL reference signal. As an example, the predictive quantization may be performed by one or more of the component 198, the transceiver(s) 1122, and/or the antennas 1180 in FIG. 11. FIG. 6 illustrates, in the context of FIGS. 7-9, an example of the XR device 602 predictively quantizing such a DL reference signal.

The XR device 602 may be configured to receive, and the UE 604 may be configured to transmit/provide, a DL reference signal 606 (DL RS) (e.g., 728 in FIG. 7). The XR device 602 may be configured to predictively quantize (at 608) (e.g., 700 in FIG. 7) the DL reference signal 606 (e.g., 728 in FIG. 7) based on a prior sample of the DL reference signal 606 (e.g., 728 in FIG. 7). In aspects, predictive quantization of the DL reference signal 606 (e.g., 728 in FIG. 7) may be based on FD sampling of the DL reference signal 606 (e.g., 728 in FIG. 7). The XR device 602 may be configured to generate a quantized representation 610 (e.g., 744 in FIG. 7; 820 in FIG. 8; 912, 918 in FIG. 9) of the DL reference signal 606 (e.g., 728 in FIG. 7) based on the predictive quantization (at 608) (e.g., 700 in FIG. 7).

At 1004, the XR device provides, for a UE, a quantized representation of the DL reference signal and a set of controlled parameters. As an example, the provision may be performed by one or more of the component 198, the transceiver(s) 1122, and/or the antennas 1180 in FIG. 11. FIG. 6 illustrates, in the context of FIGS. 7-9, an example of the XR device 602 providing/transmitting such a quantized representation to a UE (e.g., the UE 604).

The XR device 602 may be configured to provide/transmit, and the UE 604 may be configured to receive, the quantized representation 610 (e.g., 744 in FIG. 7; 820 in FIG. 8; 912, 918 in FIG. 9) of the DL reference signal 606 (e.g., 728 in FIG. 7) and a set of controlled parameters 612 (e.g., 910, 916 in FIG. 9). The XR device 602 may be configured to provide/transmit the set of controlled parameters 612 (e.g., 910, 916 in FIG. 9) in association with being configured to obtain the set of controlled parameters 612 (e.g., 910, 916 in FIG. 9). In aspects, the set of controlled parameters 612 (e.g., 910, 916 in FIG. 9) may be obtained by/at the XR device 602. The set of controlled parameters 612 (e.g., 910, 916 in FIG. 9) may include at least one of a prediction coefficient (e.g., 737 in FIG. 7), a prediction error variance (e.g., 738 in FIG. 7), an applied received signal strength indicator (RSSI) scaling coefficient (e.g., 735 in FIG. 7) associated with the prior sample of the DL reference signal 606 (e.g., 728 in FIG. 7), a direct current bias removed from the DL reference signal 606 (e.g., 728 in FIG. 7) at the XR device 602, an initial sample (e.g., 754 in FIG. 7) of the DL reference signal 606 (e.g., 728 in FIG. 7), and/or the like. The set of controlled parameters 612 (e.g., 910, 916 in FIG. 9) may further include compandor outputs, e.g., at the XR device 602, which may comprise coded unsigned bits. The set of controlled parameters 612 (e.g., 910, 916 in FIG. 9) may be obtained by the XR device 602 through calculation, selection, identification, other forms of processing, communication with the UE 604, and/or the like. In aspects, to obtain the set of controlled parameters 612 (e.g., 910, 916 in FIG. 9), the XR device 602 may be configured to obtain the prediction error variance (e.g., 738 in FIG. 7) at the XR device 602 in accordance with the prediction coefficient (e.g., 737 in FIG. 7).

In aspects, to predictively quantize (at 608) (e.g., 700 in FIG. 7) the DL reference signal 606 (e.g., 728 in FIG. 7) based on the prior sample of the DL reference signal 606 (e.g., 728 in FIG. 7), the XR device 602 may be configured to receive, from the UE 604, control signaling (e.g., 908, 914 in FIG. 9). The control signaling (e.g., 908, 914 in FIG. 9) may include at least one of a type of quantization, a number of bits for representation, a DL reference signal allocation period, an uplink resource allocation, a sampling rate (e.g., associated with TD and/or FD sampling), and/or the like. In such aspects, the XR device 602 may be configured to predictively quantize (at 608) (e.g., 700 in FIG. 7) the DL reference signal 606 (e.g., 728 in FIG. 7) further based on the control signaling (e.g., 908, 914 in FIG. 9). In aspects, to predictively quantize (at 608) (e.g., 700 in FIG. 7) the DL reference signal 606 (e.g., 728 in FIG. 7) based on the prior sample of the DL reference signal 606 (e.g., 728 in FIG. 7), the XR device 602 may be configured to generate the set of DL reference signal samples that are compressed, including to compress the set of DL reference signal samples in association with a DPCM quantizer, e.g., at the XR device 602. Accordingly, in aspects, the quantized representation 610 (e.g., 744 in FIG. 7; 820 in FIG. 8; 912, 918 in FIG. 9) of the DL reference signal 606 (e.g., 728 in FIG. 7) may comprise/include the set of DL reference signal samples that are compressed.

As noted above, the XR device 602 may be configured to provide/transmit the set of controlled parameters 612 (e.g., 910, 916 in FIG. 9) in association with being configured to obtain the set of controlled parameters 612 (e.g., 910, 916 in FIG. 9). In aspects, the set of controlled parameters 612 (e.g., 910, 916 in FIG. 9) may be obtained by the XR device 602, and may include at least one of an applied RSSI scaling coefficient (e.g., 735 in FIG. 7) associated with the prior sample of the DL reference signal 606 (e.g., 728 in FIG. 7), a direct current bias removed from the DL reference signal 606 at the XR device 602, an initial sample (e.g., 754 in FIG. 7) of the DL reference signal 606 (e.g., 728 in FIG. 7), and/or the like. In such aspects, the XR device 602 may be configured to obtain the set of controlled parameters 612 (e.g., 910, 916 in FIG. 9), including to receive, from the UE 604, at least one of a prediction coefficient (e.g., 737 in FIG. 7) or a prediction error variance (e.g., 738 in FIG. 7). The prediction coefficient (e.g., 737 in FIG. 7) and/or the prediction error variance (e.g., 738 in FIG. 7) may be associated with the prior sample of the DL reference signal 606 (e.g., 728 in FIG. 7). The set of controlled parameters may further include compandor outputs, e.g., at the XR device 602, which may comprise coded unsigned bits. The XR device 602 may be configured to predictively quantize (at 608) (e.g., 700 in FIG. 7) the DL reference signal 606 (e.g., 728 in FIG. 7) further based on at least one of the prediction coefficient (e.g., 737 in FIG. 7) or the prediction error variance (e.g., 738 in FIG. 7). In such aspects, the XR device 602 may be configured to predictively quantize (at 608) (e.g., 700 in FIG. 7) the DL reference signal 606 (e.g., 728 in FIG. 7), including to receive, from the UE 604, control signaling (e.g., 908, 914 in FIG. 9) that includes at least one of a type of quantization, a number of bits for representation, a DL reference signal allocation period, an UL resource allocation, a sampling rate, and/or the like, and the XR device 602 may be configured to predictively quantize (at 608) (e.g., 700 in FIG. 7) the DL reference signal (606) (e.g., 728 in FIG. 7) further based on the control signaling (e.g., 908, 914 in FIG. 9).

At 1006, the XR device receive, from the UE, pre-equalized data in accordance with a channel estimation associated with a reconstructed representation (e.g., 836 in FIG. 8) of the DL reference signal after quantization. As an example, the reception may be performed by one or more of the component 198, the transceiver(s) 1122, and/or the antennas 1180 in FIG. 11. FIG. 6 illustrates, in the context of FIGS. 7-9, an example of the XR device 602 receiving such pre-equalized data from a UE (e.g., the UE 604).

The XR device 602 may be configured to receive, and the UE 604 may be configured to transmit/provide, the pre-equalized data 618 (e.g., 906 in FIG. 9) in accordance with a channel estimation associated with a reconstructed representation (e.g., 836 in FIG. 8) of the DL reference signal 606 (e.g., 728 in FIG. 7) after quantization. In aspects, the reconstructed representation (e.g., 836 in FIG. 8) of the DL reference signal 606 (e.g., 728 in FIG. 7) after quantization may be based on the set of controlled parameters 612 (e.g., 910, 916 in FIG. 9) and/or the estimate (at 616) of the channel. The pre-cqualized data 618 (e.g., 906 in FIG. 9) may be of, or otherwise associated with, an XR application with which the XR device 602 is associated. The UE 604 may be configured to reconstruct (at 614) a representation (e.g., 744 in FIG. 7; 820 in FIG. 8; 912, 918 in FIG. 9) of the quantized DL reference signal. In aspects, the UE 604 may be configured to reconstruct (at 614) (e.g., 800 in FIG. 8) the representation (e.g., 744 in FIG. 7; 820 in FIG. 8; 912, 918 in FIG. 9) of the quantized DL reference signal based on the set of controlled parameters 612 (e.g., 910, 916 in FIG. 9). In some aspects, the XR device 602 may be configured to reconstruct (at 614) the representation (e.g., 744 in FIG. 7; 820 in FIG. 8; 912, 918 in FIG. 9) of the quantized DL reference signal based on the set of controlled parameters 612 (e.g., 910, 916 in FIG. 9), and to provide a reconstructed representation (e.g., 836 in FIG. 8) of the DL reference signal 606 (e.g., 728 in FIG. 7) after quantization to the UE 604 (e.g., for channel estimation and Tx pre-equalization). The UE 604 may also be configured to estimate (at 616) a channel associated with the DL reference signal 606 (e.g., 728 in FIG. 7). In aspects, the UE 604 may be configured to estimate (at 616) the channel associated with the DL reference signal 606 (e.g., 728 in FIG. 7) based on the representation (e.g., 744 in FIG. 7; 820 in FIG. 8; 912, 918 in FIG. 9) of the quantized DL reference signal and/or based on the reconstructed representation (e.g., 836 in FIG. 8) of the DL reference signal 606 (e.g., 728 in FIG. 7) after quantization. The UE 604 may be configured to perform Tx pre-equalization, e.g., for pre-equalized data 618 (e.g., 906 in FIG. 9), accordingly.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to predictively quantize a DL reference signal based on a prior sample of the DL reference signal. The component 198 may be configured to provide, for a UE, a quantized representation of the DL reference signal and a set of controlled parameters. The component 198 may be configured to receive, from the UE, pre-equalized data in accordance with a channel estimation associated with a reconstructed representation of the DL reference signal after quantization. The component 198 may be configured to reconstruct a representation of the quantized DL reference signal. The component 198 may be configured to receive, from an XR device, a quantized representation of a DL reference signal and a set of controlled parameters, where the quantized representation of the DL reference signal is based on a prior sample of the DL reference signal. The component 198 may be configured to estimate a channel associated with the DL reference signal. The component 198 may be configured to provide, for the XR device, pre-equalized data in accordance with a channel estimation from estimating the channel, where the channel estimation is associated with a reconstructed representation of the quantized DL reference signal. The component 198 may be further configured to perform any of the aspects described in connection with the flowcharts in FIG. 10, and/or any of the aspects performed by an XR device, and/or a UE, for any of FIGS. 4-9. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for predictively quantizing a DL reference signal based on a prior sample of the DL reference signal. In one configuration, the apparatus 1104, and in particular the cellular baseband processor(s) 1124 and/or the application processor(s) 1106, may include means for providing, for a UE, a quantized representation of the DL reference signal and a set of controlled parameters. In one configuration, the apparatus 1104, and in particular the cellular baseband processor(s) 1124 and/or the application processor(s) 1106, may include means for receiving, from the UE, pre-equalized data in accordance with a channel estimation associated with a reconstructed representation of the DL reference signal after quantization. In one configuration, the apparatus 1104, and in particular the cellular baseband processor(s) 1124 and/or the application processor(s) 1106, may include means for reconstructing a representation of the quantized DL reference signal. In one configuration, the apparatus 1104, and in particular the cellular baseband processor(s) 1124 and/or the application processor(s) 1106, may include means for receiving, from an XR device, a quantized representation of a DL reference signal and a set of controlled parameters, where the quantized representation of the DL reference signal is based on a prior sample of the DL reference signal. In one configuration, the apparatus 1104, and in particular the cellular baseband processor(s) 1124 and/or the application processor(s) 1106, may include means for estimating a channel associated with the DL reference signal. In one configuration, the apparatus 1104, and in particular the cellular baseband processor(s) 1124 and/or the application processor(s) 1106, may include means for providing, for the XR device, pre-equalized data in accordance with a channel estimation from estimating the channel, where the channel estimation is associated with a reconstructed representation of the quantized DL reference signal. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

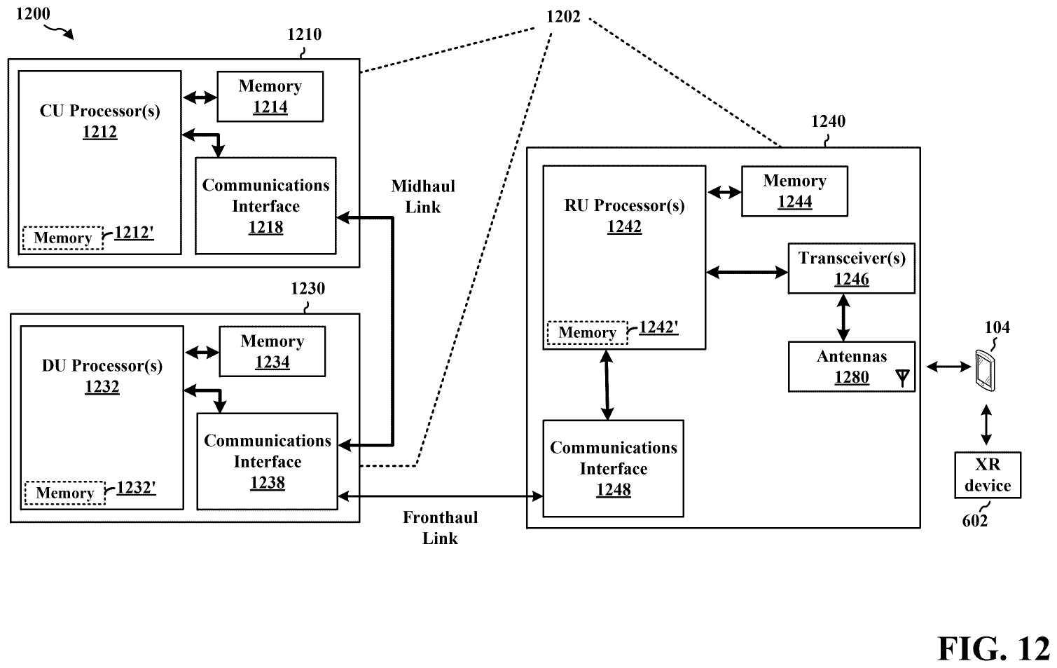

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104, which may in turn communicate with the XR device 602. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As described supra, the network entity 1202 may include the TX processor 316, the RX processor 370, and the controller/processor 375. As such, in one configuration, the means may be the TX processor 316, the RX processor 370, and/or the controller/processor 375 configured to perform various functions herein.

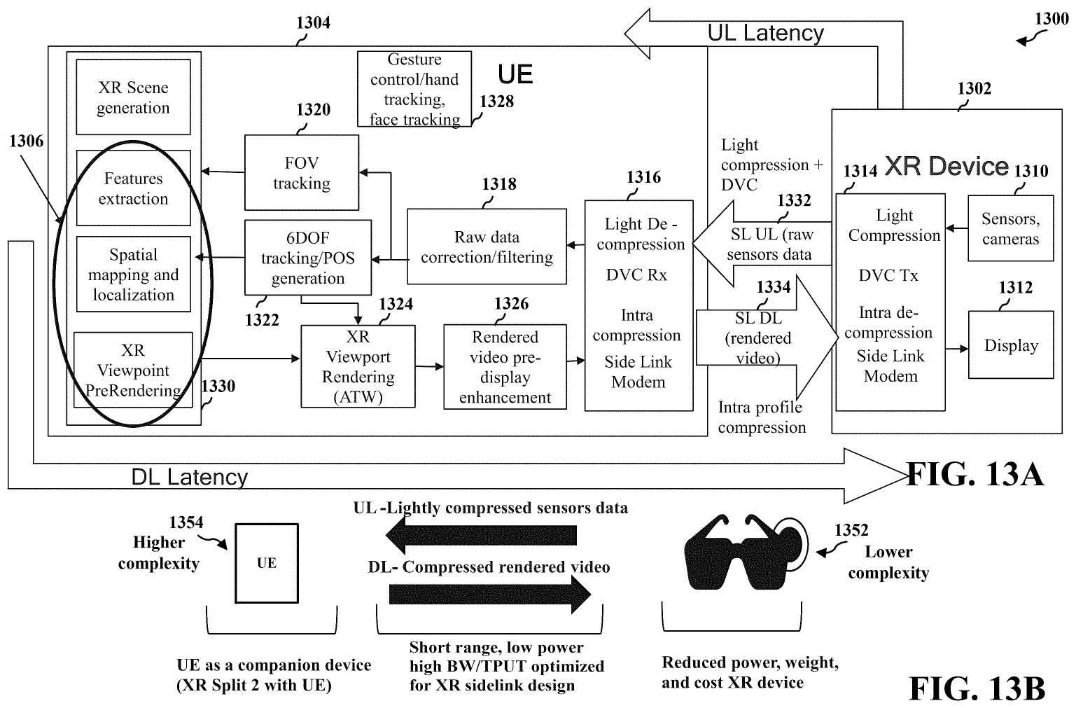

FIG. 13A is a diagram showing an example XR split architecture 1300, e.g., a split of XR processing between an XR device 1302 and a companion device, such as a UE 1304. The arrow at 1306 illustrates example functionality that may be further offloaded to the network, such as to a base station, in an example of an option with a split across an XR device, a UE, and an edge server at a base station. FIG. 13A illustrates that the XR device 1302 may include a sensor 1310, such as a camera, and a display 1312. The XR device may have one or more components 1314 configured to perform light compression of the sensor data, distributed video coding (DVC) transmission, decompression of the rendered video from the UE, and sidelink modem processing to provide video to the display 1312. The companion device (e.g., UE 1304) may include one or more components 1316 to perform light decompression of the sensor data 1332 from the XR device 1302, DVC reception, and intra-compression for sidelink communication. The UE may perform raw data correction and filtering, as shown at 1318 to provide tracking and/or POS information, as shown at 1320 and 1322. In some aspects, the UE may include gesture control and/or hand or face tracking, as shown at 1328. The UE may provide the tracking or POS information to a component 1330 that performs XR scene generation, feature extraction, spatial mapping and localization and/or XR viewpoint prerendering based on the tracking and POS information. As shown at 1324, the UE may perform XR viewport rendering and enhance the video for display, at 1326 before providing the rendered video, e.g., over sidelink or downlink to the XR device 1302, at 1334.

FIG. 13B illustrates an example of a lower complexity device that supports XR traffic, e.g., that may be referred to as an XR device 1352 that provides sensor data to a higher complexity companion device, which may be a UE 1354. The UE 1354 then provides compressed rendered video for display at the XR device 1352. Through the use of the UE to perform some of the XR processing of the sensor data and/or received video, the XR device 1352 can perform less complex processing to display the video based on the sensor data. The split may enable smaller, more lightweight components for the XR device while enabling a robust XR user experience.

In some aspects, the split XR approach may be for a wearable XR device, e.g., which may be referred to as an “on the go” wearable XR device. In some aspects, the XR device 1302 may offload processing, e.g., full processing, to the UE 1304. The split may allow for an XR device that is closer to an input/output (I/O) device. The XR device 1302 may share or forward the XR device sensors/cameras data to the UE via an uplink or a sidelink. An uplink link may provide a higher throughput over a local short link, and/or lower power consumption at the XR device for sensor processing, video compression and modem operation. In some aspects, the XR device may not perform sensor or camera data processing before forwarding the sensor/camera data to the UE 1304. In some aspects, the XR device 1302 may not perform rendered video processing before displaying the video data from the UE 1304. The UE may process, e.g., pre-process, the video, which may help to reduce latency for the link between the UE to the XR device. For example, there may be a negligible link latency for the UE to XR device link.

In some aspects, the XR device 1302 may perform light compression and DVC for the uplink data (e.g., sensor/camera data) to minimize the video encoding related power consumption of the XR device. In some aspects, the XR device 1302 may use a compression mode that is optimized for a minimum encoder power consumption, such as having a compromised compression factor (e.g., beyond options such as H264, H265). In some aspects, the complexity shift from the encoder side (e.g., at the XR device 1302) to the decoder side (e.g., at the UE 1304) may be the opposite of a structure in which the encoder carriers more complexity. The aspects enable the power consumption for the video compression to be shifted (e.g., lower compression factor) to power consumption for communication (e.g., a higher throughout) to achieve a lower overall power budget. The reduction in the power consumption may be based on a short-range, low power communication, e.g., which may be over an unlicensed frequency band. In some aspects, DVC may be employed for extra compression of the uplink data to the UE via channel coding, e.g., which may involve near zero power on the transmission side (at the XR device) and shifts the complexity to the receiver side (at the UE). DVC combining with a video encoder (with joint compression and channel coding) may involve video coding options not employing an entropy encoder. In some aspects, the communication between the XR device 1302 and the UE 1304 maybe in an RF band RF for an XR local link or sidelink. As one example, the communication may be in ultrawide band frequency range (UWB), e.g., such as 7-10.6 [GHz] for ultrawide band communication with a short range, low power high bandwidth and throughput link. In some aspects, short range ultrawide band communication enables a lower complexity for full duplex communication, e.g., which may allow for a low latency link with doubled channel capacity through transmission and reception that overlap in time. In some aspects, the communication may be based on XR optimized lower power sidelink connection, such as for new radio unlicensed (NRU) on top of Wi-Fi bands. In some aspects, a base station may control channel access over an UWB with resources reused across different neighbor XR locations. For example, the base station may provide semi-persistent resource assignments via the UE 1304. The resource assignments may be based on mutual interference or coupling reports for the UWB and/or multi-XR device synchronization within a co-scheduling group.

In some aspects the communication between the UE and the XR device may be based on a waveform that is optimized for lower power XR traffic over a local link band (e.g., such as UWB, Sidelink NRU, or WIFI band). The XR receiver side modem complexity may be shifted to the transmitter side of the link (e.g., from XR device 1302 to the companion UE 1304) for XR baseband modem power reduction at the XR device. As an example, the traffic from the UE may be based on transmission space-frequency pre-equalization for downlink, a UE driven synchronization loop for XR, UE driven/assisted channel estimation for XR reception, and/or a lighter complexity channel coding scheme. The XR traffic may include video aware mixed analog/digital communication for XR, graceful video QoS and user experience adaptation to channel capacity/allocated resources. In some aspects, cross-layer optimizations may be used for the XR communication, e.g., with a strong coupling between a PHY layer and video compression for the XR communication.

In some aspects, the XR device may not do double data rate (DDR) processing for the XR traffic. For example, the XR device may perform intra frame prediction for video compression, which may be referred to as a light, or lighter, compression scheme for uplink and Intra profile of H264 or similar usage for downlink. In some aspects, the XR device 1302 may perform pipelined small data chunk processing from the receiver PHY output until display (e.g., for the XR receiver-side) and from the sensors/cameras output until transmission PHY (e.g., for the XR transmission-side). In some aspects, the XR device may store compressed data, e.g., and not uncompressed data. For example, the XR device may have an intermediate small volume buffer between PHY and upper layers. The XR may stagger time channel use and processing for different sensors, cameras, eyes, and/or displays.

The examples described in connection with FIGS. 13A and 13B illustrate an example design with modular components and extensions that may be applied for various types of wireless communication, including AR, XR, and/or VR traffic with a companion UE. In some aspects, the companion UE may be referred to as a “UE in the pocket.”

As described in connection with the example split XR scenario of FIG. 13A and FIG. 13B, employing an aggressive XR functionality split so that more processing is performed at the companion device than the XR device may enable the XR device to operate as an I/O device (or nearly an I/O device). For example, receiver complexity at the XR device may be shifted from the XR device to the companion device. Additionally, moving additional or alternate functional components from the XR device to the companion device, such as the PHY layer-related complexity and/or modem-related complexity, may further facilitate achieving a low-weight, low complexity, and low power consumption XR device that may be wearable and facilitate “on the go” usage.

An XR device may communicate with a UE or a puck through a sidelink connection in 5G NR, 6G, and/or the like, to facilitate the usage of XR applications. XR traffic may include communications for VR, MR, AR, and/or the like. XR devices may include XR glasses, XR goggles, and/or other XR devices to provide a user with an XR experience. However, XR technology has many challenges and unsolved issues that limit readiness for massive commercialization and adoption. Among such issues are being light-weight appropriate for long-time use, e.g., “on the go,” ideally comparable with a regular eye glasses which have approximately 30 g to 40 g weight, as XR devices may thus rely on a light weigh battery among the rest. Additionally, issues include limited processing complexity and power consumption to comply with available heat dissipation ability on the XR glasses/XR goggles/other XR devices (e.g., which may be much smaller than a typical UE for example, such as a smartphone, as it is proportional to the surface size of goggles/glasses, which is much smaller). For smart XR wearable goggles, the power consumption limit from the point of view of heat dissipation may be limited to only few watts. Likewise, reasonable power consumption to allow a light weight battery and a reasonable battery lifetime is also an issue. These issues are extremely challenging keeping in mind that heavy processing may be utilized to support many XR applications. A stand-alone XR product may not comply with the above “on the go” requirements and may be relevant only for some specific applications/static- and short-time usage scenarios, which allow to assume a higher form factor HMD usage. Because most application/scenario usage of high form factor HMD is not convenient, part of XR related processing may be shifted to a companion device with a split XR approach to reduce complexity on the XR device. A typical split XR approach moves most of the rendering related processing to a companion device, but many processing components are still left on the XR device for different E2E considerations (e.g., a photon-to-motion latency consideration, an XR-to-companion device wireless link capacity, communication link power consumption for long range links, etc.). And while existing split XR options significantly reduce power consumption on XR devices, the power consumption is still too high even for a less demanding video quality/user experience benchmark and less demanding applications such that this split scenario does not completely solve the technology-limiting factors mentioned above, and does not allow support of more demanding premium XR application (e.g., where frames per second (fps)≥120 Hz, where video formats ≥8 k, etc.). The split options above may assume long range communication links over licensed spectrum with tight scheduling and staggering among different served XR users. Capacity per user may be a primary issue for this case, and correspondingly, an XR device may employ some sensors processing locally to reduce UL data volume (e.g., 6DOF tracking, eye tracking for FOV derivation, etc.), while the additional critical sensor/camera data from XR (e.g., UL) and the rendered video for the XR device (e.g., DL) may be compressed with a high compression factor (e.g., due to a limited link capacity per user). A sensor's data pre-processing on an XR device and video compression with a sufficiently high compression factor (e.g. the high profile of H264) have a high complexity, such as for the encoder side, and utilize extensive DDR usage for both Tx/Rx path video processing. Additionally, DDR is a heavy power consumer itself. Further, due to photon-to-motion latency budgets and base station/gNB based split related latencies, Rx side processing on an XR device also includes ATW for last moment image alignment with the latest pose information. Other XR split approaches assume processing offloading with tethering to a relatively close companion device (e.g., a UE, a puck, etc.) or a processing split between the XR device, a companion UE, and a base station/gNB. From the XR device perspective, such a split assumes a similar processing load and locally covered functionality on the XR device side, but with a local short range communication link with the associated UE (such as a 5G NR sidelink or Wi-Fi™) which allows reductions specifically in modem-related power consumption.

Aspects herein for prediction based FD quantizers for DL RS samples indication to support Tx pre-equalization provide a low complexity CSI refresh procedure, at the Rx side, based on a DL RS sampling and quantization scheme used for DL RS samples indication/reporting with low UL overhead for scenarios without channel reciprocity and optimized for a high SNR regime. Additionally, aspects provide low-power/low-complexity UWB based XR sidelink communications in 6G networks, and are applicable for any other power-/battery-limited device scenario, link type, band, application, and/or the like. Aspects mediate arbitrary FD samples correlation and STO associated with the DL RS samples by providing a low complexity CSI refresh procedure relying on efficient DL RS sampling and quantization/compression scheme. Aspects reduce modem power consumption at the XR device (e.g., the Rx side of the modem/link) by a shifting of the channel estimation and equalization related complexity and functionality from the XR device to its companion device/UE (e.g., the Tx side of the link). Aspects allow frequent CSI refresh (with a robust Tx pre-equalization-based scheme) for scenarios where a channel reciprocity assumption is not held by providing a DL RS samples indication with low UL overhead based on an efficient sampling and quantization scheme. Aspects enable a smaller XR device battery size and lower XR device weight by providing a negligible complexity CSI refresh procedures from the Rx side perspective (e.g., in a battery and complexity limited device), and by providing simplified XR modem hardware. Aspects bring XR devices closer to an “XR as I/O device” platform by providing an aggressive complexity off-loading from the XR device perspective (e.g., for modem complexity). It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1. A method of wireless communication at an extended reality (XR) device, comprising: predictively quantizing a downlink (DL) reference signal based on a prior sample of the DL reference signal; providing, for a user equipment (UE), a quantized representation of the DL reference signal and a set of controlled parameters; and receiving, from the UE, pre-equalized data in accordance with a channel estimation associated with a reconstructed representation of the DL reference signal after quantization.
Aspect 2. The method of aspect 1, wherein the reconstructed representation of the DL reference signal after quantization is based on the set of controlled parameters.
Aspect 3. The method of any of aspects 1 and 2, wherein providing the set of controlled parameters includes: obtaining the set of controlled parameters; wherein the set of controlled parameters includes at least one of a prediction coefficient, a prediction error variance, an applied received signal strength indicator (RSSI) scaling coefficient associated with the prior sample of the DL reference signal, a direct current bias removed from the DL reference signal at the XR device, or an initial sample of the DL reference signal.
Aspect 4. The method of aspect 3, wherein obtaining the set of controlled parameters includes: obtaining the prediction error variance at the XR device in accordance with the prediction coefficient.
Aspect 5. The method of aspect 4, wherein predictively quantizing the DL reference signal based on the prior sample of the DL reference signal includes: receiving, from the UE, control signaling that includes at least one of a type of quantization, a number of bits for representation, a DL reference signal allocation period, an uplink resource allocation, or a sampling rate; wherein predictively quantizing the DL reference signal is further based on the control signaling.
Aspect 6. The method of aspect 3, wherein predictively quantizing the DL reference signal based on the prior sample of the DL reference signal includes: generating the set of DL reference signal samples that are compressed by compressing the set of DL reference signal samples in association with a differential pulse code modulation (DPCM) quantizer, wherein the quantized representation of the DL reference signal comprises the set of DL reference signal samples that are compressed.
Aspect 7. The method of aspect 3, wherein the set of controlled parameters further includes compandor outputs comprising coded unsigned bits.
Aspect 8. The method of any of aspects 1 and 2, wherein providing the set of controlled parameters includes: obtaining the set of controlled parameters; wherein the set of controlled parameters includes at least one of an applied received signal strength indicator (RSSI) scaling coefficient associated with the prior sample of the DL reference signal, a direct current bias removed from the DL reference signal at the XR device, or an initial sample of the DL reference signal.
Aspect 9. The method of aspect 8, wherein obtaining the set of controlled parameters includes: receiving, from the UE, at least one of a prediction coefficient or a prediction error variance, wherein at least one of the prediction coefficient or the prediction error variance is associated with the prior sample of the DL reference signal; wherein predictively quantizing the DL reference signal is further based on at least one of the prediction coefficient or the prediction error variance.
Aspect 10. The method of aspect 9, wherein predictively quantizing the DL reference signal based on the prior sample of the DL reference signal includes: receiving, from the UE, control signaling that includes at least one of a type of quantization, a number of bits for representation, a DL reference signal allocation period, an uplink resource allocation, or a sampling rate; wherein predictively quantizing the DL reference signal is further based on the control signaling.
Aspect 11. The method of aspect 8, wherein the set of controlled parameters further includes compandor outputs comprising coded unsigned bits.
Aspect 12. The method of any of aspects 1 to 11, wherein predictively quantizing the DL reference signal based on the prior sample of the DL reference signal includes: receiving, from the UE, the DL reference signal.
Aspect 13. The method of any of aspects 1 to 12, wherein the pre-equalized data is of an XR application with which the XR device is associated.
Aspect 14. The method of any of aspects 1 to 13, wherein at least one of providing the quantized representation of the DL reference signal and the set of controlled parameters or receiving the pre-equalized data is based on sidelink signaling between the XR device and the UE.
Aspect 15. The method of any of aspects 1 to 14, wherein predictively quantizing the DL reference signal is further based on frequency domain sampling of the DL reference signal.
Aspect 16. An apparatus for wireless communication at an extended reality (XR) device, comprising: at least one memory; and at least one processor coupled to the at least one memory, the at least one processor, individually or in any combination, is configured to perform the method of any of aspects 1 to 15.
Aspect 17. An apparatus for wireless communication at an extended reality (XR) device, comprising means for performing each step in the method of any of aspects 1 to 15.
Aspect 18. The apparatus of any of aspects 16 and 17, further comprising a transceiver configured to receive or to transmit in association with the method of any of aspects 1 to 15.
Aspect 19. A computer-readable medium (e.g., a non-transitory computer-readable medium) storing computer executable code at an extended reality (XR) device, the code when executed by at least one processor causes the at least one processor to perform the method of any of aspects 1 to 15.

What is claimed is:

1. An apparatus for wireless communication at an extended reality (XR) device, comprising:
at least one memory; and
at least one processor coupled to the at least one memory and, based at least in part on information stored in the at least one memory, the at least one processor, individually or in any combination, is configured to:
predictively quantize a downlink (DL) reference signal based on a prior sample of the DL reference signal;
provide, for a user equipment (UE), a quantized representation of the DL reference signal and a set of controlled parameters; and
receive, from the UE, pre-equalized data in accordance with a channel estimation associated with a reconstructed representation of the DL reference signal after quantization.

2. The apparatus of claim 1, wherein the reconstructed representation of the DL reference signal after the quantization is based on the set of controlled parameters.

3. The apparatus of claim 1, wherein to provide the set of controlled parameters, the at least one processor, individually or in any combination, is configured to:
obtain the set of controlled parameters;
wherein the set of controlled parameters includes at least one of a prediction coefficient, a prediction error variance, an applied received signal strength indicator (RSSI) scaling coefficient associated with the prior sample of the DL reference signal, a direct current bias removed from the DL reference signal at the XR device, or an initial sample of the DL reference signal.

4. The apparatus of claim 3, wherein to obtain the set of controlled parameters, the at least one processor, individually or in any combination, is configured to:
obtain the prediction error variance at the XR device in accordance with the prediction coefficient.

5. The apparatus of claim 4, wherein to predictively quantize the DL reference signal based on the prior sample of the DL reference signal, the at least one processor, individually or in any combination, is configured to:
receive, from the UE, control signaling that includes at least one of a type of quantization, a number of bits for representation, a DL reference signal allocation period, an uplink resource allocation, or a sampling rate;
wherein to predictively quantize the DL reference signal, the at least one processor, individually or in any combination, is configured to predictively quantize the DL reference signal further based on the control signaling.

6. The apparatus of claim 3, wherein to predictively quantize the DL reference signal based on the prior sample of the DL reference signal, the at least one processor, individually or in any combination, is configured to:
generate the set of DL reference signal samples that are compressed by compressing the set of DL reference signal samples in association with a differential pulse code modulation (DPCM) quantizer, wherein the quantized representation of the DL reference signal comprises the set of DL reference signal samples that are compressed.

7. The apparatus of claim 3, wherein the set of controlled parameters further includes compandor outputs comprising coded unsigned bits.

8. The apparatus of claim 1, wherein to provide the set of controlled parameters, the at least one processor, individually or in any combination, is configured to:
obtain the set of controlled parameters;
wherein the set of controlled parameters includes at least one of an applied received signal strength indicator (RSSI) scaling coefficient associated with the prior sample of the DL reference signal, a direct current bias removed from the DL reference signal at the XR device, or an initial sample of the DL reference signal.

9. The apparatus of claim 8, wherein to obtain the set of controlled parameters, the at least one processor, individually or in any combination, is configured to:
receive, from the UE, at least one of a prediction coefficient or a prediction error variance, wherein at least one of the prediction coefficient or the prediction error variance is associated with the prior sample of the DL reference signal;
wherein to predictively quantize the DL reference signal, the at least one processor, individually or in any combination, is configured to predictively quantize the DL reference signal further based on at least one of the prediction coefficient or the prediction error variance.

10. The apparatus of claim 9, wherein to predictively quantize the DL reference signal based on the prior sample of the DL reference signal, the at least one processor, individually or in any combination, is configured to:
receive, from the UE, control signaling that includes at least one of a type of quantization, a number of bits for representation, a DL reference signal allocation period, an uplink resource allocation, or a sampling rate;
wherein to predictively quantize the DL reference signal, the at least one processor, individually or in any combination, is configured to predictively quantize the DL reference signal further based on the control signaling.

11. The apparatus of claim 8, wherein the set of controlled parameters further includes compandor outputs comprising coded unsigned bits.

12. The apparatus of claim 1, further comprising at least one transceiver coupled to the at least one processor;
wherein to predictively quantize the DL reference signal based on the prior sample of the DL reference signal, the at least one processor, individually or in any combination, is configured to:
receive, from the UE and via the at least one transceiver, the DL reference signal.

13. The apparatus of claim 1, wherein the pre-equalized data is of an XR application with which the XR device is associated.

14. The apparatus of claim 1, wherein to provide the quantized representation of the DL reference signal and the set of controlled parameters or to receive the pre-equalized data, the at least one processor, individually or in any combination, is configured to provide the quantized representation or to receive the pre-equalized data based on sidelink signaling between the XR device and the UE.

15. The apparatus of claim 1, wherein to predictively quantize the DL reference signal, the at least one processor, individually or in any combination, is configured to predictively quantize the DL reference signal further based on frequency domain sampling of the DL reference signal.

16. A method of wireless communication at an extended reality (XR) device, comprising:
predictively quantizing a downlink (DL) reference signal based on a prior sample of the DL reference signal;
providing, for a user equipment (UE), a quantized representation of the DL reference signal and a set of controlled parameters; and
receiving, from the UE, pre-equalized data in accordance with a channel estimation associated with a reconstructed representation of the DL reference signal after quantization.

17. The method of claim 16, wherein the reconstructed representation of the DL reference signal after the quantization is based on the set of controlled parameters, wherein providing the set of controlled parameters includes:
obtaining the set of controlled parameters; and
wherein the set of controlled parameters includes at least one of a prediction coefficient, a prediction error variance, an applied received signal strength indicator (RSSI) scaling coefficient associated with the prior sample of the DL reference signal, a direct current bias removed from the DL reference signal at the XR device, or an initial sample of the DL reference signal, or
wherein the set of controlled parameters includes at least one of the applied RSSI scaling coefficient associated with the prior sample of the DL reference signal, the direct current bias removed from the DL reference signal at the XR device, or the initial sample of the DL reference signal.

18. The method of claim 17, wherein obtaining the set of controlled parameters includes:
obtaining the prediction error variance at the XR device in accordance with the prediction coefficient,
wherein predictively quantizing the DL reference signal based on the prior sample of the DL reference signal includes:
receiving, from the UE, control signaling that includes at least one of a type of quantization, a number of bits for representation, a DL reference signal allocation period, an uplink resource allocation, or a sampling rate,
wherein predictively quantizing the DL reference signal is further based on the control signaling; or
receiving, from the UE, at least one of the prediction coefficient or the prediction error variance, wherein at least one of the prediction coefficient or the prediction error variance is associated with the prior sample of the DL reference signal,
wherein predictively quantizing the DL reference signal is further based on at least one of the prediction coefficient or the prediction error variance,
wherein predictively quantizing the DL reference signal based on the prior sample of the DL reference signal includes:
receiving, from the UE, control signaling that includes at least one of the type of the quantization, the number of bits for the representation, the DL reference signal allocation period, the uplink resource allocation, or the sampling rate;
wherein predictively quantizing the DL reference signal is further based on the control signaling.

19. The method of claim 18, wherein predictively quantizing the DL reference signal based on the prior sample of the DL reference signal includes:
generating the set of DL reference signal samples that are compressed by compressing the set of DL reference signal samples in association with a differential pulse code modulation (DPCM) quantizer, wherein the quantized representation of the DL reference signal comprises the set of DL reference signal samples that are compressed.

20. A computer-readable medium storing computer executable code at an extended reality (XR) device, the code when executed by at least one processor causes the at least one processor to:
predictively quantize a downlink (DL) reference signal based on a prior sample of the DL reference signal;
provide, for a user equipment (UE), a quantized representation of the DL reference signal and a set of controlled parameters; and
receive, from the UE, pre-equalized data in accordance with a channel estimation associated with a reconstructed representation of the DL reference signal after quantization.
